(19) United States
(12) Patent Application Publication
(10) Pub. No.: US 2023/0403733 A1
(43) Pub. Date: Dec. 14, 2023

(54) SIDELINK RESOURCE ALLOCATION IN UNLICENSED SPECTRUM

(71) Applicant: QUALCOMM INCORPORATED, San Diego, CA (US)

(72) Inventors: Shuanshuan Wu, San Diego, CA (US); Arthur Gubeskys, San Diego, CA (US); Stelios Stefanatos, San Diego, CA (US); Kapil Gulati, Belle Mead, NJ (US); Shailesh Patil, San Diego, CA (US); Parisa Cheraghi, Cambridge (GB)

(21) Appl. No.: 18/249,360

(22) PCT Filed: Nov. 18, 2021
(86) PCT No.: PCT/US2021/072484

§ 371 Date: Apr. 17, 2023

(30) Foreign Application Priority Data
Dec. 18, 2020 (GR) 20200100740

(51) Int. Cl. H04W 72/542; H04W 72/0453; H04W 74/08

(52) U.S. Cl. CPC H04W 72/542; H04W 72/0453; H04W 74/0808

(57) ABSTRACT

Methods, systems, and devices for wireless communication are described to support configuring a user equipment (UE) operating in unlicensed spectrum with a set of component carriers (CCs) for sidelink communications using the unlicensed spectrum. In a first example, a UE may select a CC from the set of candidate CCs, for example, using a carrier selection configuration, and may select a resource in the CC for a sidelink communication. In a second example, a UE may select multiple candidate resources for a sidelink communication, for example, using a resource selection configuration and based on sensing performed by the UE. To indicate the reservation of a candidate resource, the UE may indicate both a CC in which the reserved resource is located and a location of the reserved resource within the carrier. The UE may transmit a sidelink message using a selected candidate resource in the unlicensed spectrum.

### CROSS REFERENCES

The present application is a 371 national stage filing of International PCT Application No. PCT/US2021/072484 by Wu et al. entitled “SIDELINK RESOURCE ALLOCATION IN UNLICENSED SPECTRUM,” filed Nov. 18, 2021; and claims priority to Greek Patent Application No. 20200100740 by Wu et al. entitled “SIDELINK RESOURCE ALLOCATION IN UNLICENSED SPECTRUM,” filed Dec. 18, 2020, each of which is assigned to the assignee hereof, and each of which is expressly incorporated by reference in its entirety herein.

### FIELD OF TECHNOLOGY

The following relates to wireless communication, including sidelink resource allocation in unlicensed spectrum.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

A UE may communicate with one or more other UEs via a sidelink channel (e.g., sidelink transmissions over the sidelink channel). In some cases, the sidelink channel may be located in a shared or unlicensed spectrum and may experience interference from other wireless communications technologies in the shared spectrum.

### SUMMARY

The described techniques relate to improved methods, systems, devices, and apparatuses that support sidelink resource allocation in unlicensed spectrum. Generally, the described techniques provide for configuring a user equipment (UE) operating in unlicensed spectrum with a set of defined candidate component carriers (CCs) for sidelink communications using the unlicensed spectrum (e.g., as defined by a wireless communications standard). In a first example, a transmitting UE may select a carrier (e.g., a CC) from the set of candidate CCs and may select one or multiple resources in the selected CC for a sidelink communication. For example, the UE may identify a carrier selection configuration to select a CC from the set of CCs, for transmitting a sidelink communication. The UE may select the CC for the sidelink communication based on a metric evaluated for each of the set of CCs over a defined time window (e.g., based on the carrier selection configuration). The transmitting UE may, for example, select the CC based on the CC being associated with a metric indicating higher communication quality (e.g., indicating lower interference in the CC). The UE may transmit a sidelink message using a resource of the selected CC in the unlicensed spectrum (e.g., via a shared radio frequency band).

In a second example, a transmitting UE may select one or multiple resources for a sidelink communication, where the one or multiple resources may be in a same CC or in two or more different CCs (e.g., of the set of CCs). For example, the UE may use a resource selection configuration to select a resource from any CC of the set of CCs for communicating a sidelink message, based on sensing performed by the UE. In one example, the UE may use the resource selection configuration to identify candidate resources across the set of CCs and may perform sensing within a sensing window to select one or more of the candidate resources (e.g., based on sensing performed by the UE). To indicate the reservation of a candidate resource, the transmitting UE may indicate both a carrier (e.g., CC) in which the reserved resource is located and a location of the reserved resource within the carrier (via sidelink control information (SCI)). The UE may transmit a sidelink message using a selected candidate resource in the unlicensed spectrum.

A method for wireless communication at a user equipment (UE) is described. The method may include identifying a carrier selection configuration for selecting between a set of multiple CCs for sidelink communications within a shared radio frequency spectrum band, selecting a first CC of the set of multiple CCs in accordance with the carrier selection configuration, and communicating a first sidelink message within a first resource of the shared radio frequency spectrum band using the first CC.

An apparatus for wireless communication at a UE is described. The apparatus may include a processor, memory in electronic communication with the processor, and instructions stored in the memory. The instructions may be executable by the processor to cause the apparatus to identify a carrier selection configuration for selecting between a set of multiple CCs for sidelink communications within a shared radio frequency spectrum band, select a first CC of the set of multiple CCs in accordance with the carrier selection configuration, and communicate a first sidelink message within a first resource of the shared radio frequency spectrum band using the first CC.

Another apparatus for wireless communication at a UE is described. The apparatus may include means for identifying a carrier selection configuration for selecting between a set of multiple CCs for sidelink communications within a shared radio frequency spectrum band, means for selecting a first CC of the set of multiple CCs in accordance with the carrier selection configuration, and means for communicating a first sidelink message within a first resource of the shared radio frequency spectrum band using the first CC.

A non-transitory computer-readable medium storing code for wireless communication at a UE is described. The code may include instructions executable by a processor to identify a carrier selection configuration for selecting between a set of multiple CCs for sidelink communications within a shared radio frequency spectrum band, select a first CC of the set of multiple CCs in accordance with the carrier selection configuration, and communicate a first sidelink message within a first resource of the shared radio frequency spectrum band using the first CC.

In some examples of the method, apparatuses, and non-transitory computer-readable medium described herein, identifying the carrier selection configuration may include operations, features, means, or instructions for identifying the carrier selection configuration that indicates a channel metric, where the first CC may be selected based on the channel metric.

In some examples of the method, apparatuses, and non-transitory computer-readable medium described herein, identifying the carrier selection configuration may include operations, features, means, or instructions for identifying the carrier selection configuration that indicates a time window and a channel metric and monitoring the set of multiple CCs within the time window based on the channel metric, where the first CC may be selected based on the monitoring.

In some examples of the method, apparatuses, and non-transitory computer-readable medium described herein, identifying the carrier selection configuration may include operations, features, means, or instructions for identifying the carrier selection configuration that indicates an interference metric and monitoring the set of multiple CCs based on the interference metric, where the first CC may be selected based on the monitoring indicating that the first CC satisfies an interference criterion associated with the interference metric.

In some examples of the method, apparatuses, and non-transitory computer-readable medium described herein, identifying the carrier selection configuration may include operations, features, means, or instructions for identifying the carrier selection configuration that indicates a sidelink congestion metric and monitoring the set of multiple CCs based on the sidelink congestion metric, where the first CC may be selected based on the monitoring indicating that the first CC satisfies a congestion criterion associated with the sidelink congestion metric.

In some examples of the method, apparatuses, and non-transitory computer-readable medium described herein, identifying the carrier selection configuration may include operations, features, means, or instructions for identifying the carrier selection configuration that indicates an interference metric corresponding to a sidelink transmission gap and monitoring the set of multiple CCs within the sidelink transmission gap based on the interference metric, where the first CC may be selected based on the monitoring indicating that the first CC satisfies an interference criterion associated with the interference metric for the sidelink transmission gap.

In some examples of the method, apparatuses, and non-transitory computer-readable medium described herein, identifying the carrier selection configuration may include operations, features, means, or instructions for identifying the carrier selection configuration that indicates a resource reservation monitoring configuration and monitoring at least one resource on at least one of the set of multiple CCs based on the resource reservation monitoring configuration, where the first CC may be selected based on the monitoring indicating that the at least one resource on the at least one of the set of multiple CCs satisfies a resource reservation criterion.

In some examples of the method, apparatuses, and non-transitory computer-readable medium described herein, identifying the carrier selection configuration may include operations, features, means, or instructions for identifying the carrier selection configuration that indicates a congestion control metric and monitoring the set of multiple CCs based on the congestion control metric, where the first CC may be selected based on the monitoring indicating that the first CC satisfies a congestion control criterion associated with the congestion control metric.

Some examples of the method, apparatuses, and non-transitory computer-readable medium described herein may further include operations, features, means, or instructions for identifying a carrier reselection configuration associated with the carrier selection configuration, monitoring the set of multiple CCs to select a second CC based on the carrier reselection configuration, and communicating a second sidelink message within a second resource of the shared radio frequency spectrum band using the second CC.

Some examples of the method, apparatuses, and non-transitory computer-readable medium described herein may further include operations, features, means, or instructions for selecting the first resource and a second resource of the shared radio frequency spectrum band corresponding to the first CC, where the first sidelink message indicates the second resource.

In some examples of the method, apparatuses, and non-transitory computer-readable medium described herein, identifying the carrier selection configuration may include operations, features, means, or instructions for identifying the carrier selection configuration that indicates a set of multiple metrics and monitoring the set of multiple CCs based on the set of multiple metrics, where the first CC may be selected based on the monitoring.

A method for wireless communication at a UE is described. The method may include identifying a resource selection configuration for resource selection between a set of multiple candidate resources of a set of multiple CCs for sidelink communications within a shared radio frequency spectrum band, performing sensing within a sensing window for selecting a first candidate resource of the set of multiple candidate resources on a first CC of the set of multiple CCs based on the resource selection configuration, transmitting a first sidelink control message indicating a carrier index of the first CC and a resource allocation corresponding to the first candidate resource, and communicating a first sidelink message within the first candidate resource of the shared radio frequency spectrum band using the first CC.

An apparatus for wireless communication at a UE is described. The apparatus may include a processor, memory in electronic communication with the processor, and instructions stored in the memory. The instructions may be executable by the processor to cause the apparatus to identify a resource selection configuration for resource selection between a set of multiple candidate resources of a set of multiple CCs for sidelink communications within a shared radio frequency spectrum band, perform sensing within a sensing window for selecting a first candidate resource of the set of multiple candidate resources on a first CC of the set of multiple CCs based on the resource selection configuration, transmit a first sidelink control message indicating a carrier index of the first CC and a resource allocation corresponding to the first candidate resource, and communicate a first sidelink message within the first candidate resource of the shared radio frequency spectrum band using the first CC.

Another apparatus for wireless communication at a UE is described. The apparatus may include means for identifying a resource selection configuration for resource selection between a set of multiple candidate resources of a set of multiple CCs for sidelink communications within a shared radio frequency spectrum band, means for performing sensing within a sensing window for selecting a first candidate resource of the set of multiple candidate resources on a first CC of the set of multiple CCs based on the resource selection configuration, means for transmitting a first sidelink control message indicating a carrier index of the first CC and a resource allocation corresponding to the first candidate resource, and means for communicating a first sidelink message within the first candidate resource of the shared radio frequency spectrum band using the first CC.

A non-transitory computer-readable medium storing code for wireless communication at a UE is described. The code may include instructions executable by a processor to identify a resource selection configuration for resource selection between a set of multiple candidate resources of a set of multiple CCs for sidelink communications within a shared radio frequency spectrum band, perform sensing within a sensing window for selecting a first candidate resource of the set of multiple candidate resources on a first CC of the set of multiple CCs based on the resource selection configuration, transmit a first sidelink control message indicating a carrier index of the first CC and a resource allocation corresponding to the first candidate resource, and communicate a first sidelink message within the first candidate resource of the shared radio frequency spectrum band using the first CC.

In some examples of the method, apparatuses, and non-transitory computer-readable medium described herein, transmitting the first sidelink control message may include operations, features, means, or instructions for transmitting the first sidelink control message indicating the resource allocation that indicates a time location, a frequency location, or both, of the first candidate resource.

In some examples of the method, apparatuses, and non-transitory computer-readable medium described herein, identifying the resource selection configuration may include operations, features, means, or instructions for identifying the resource selection configuration that indicates that the sensing window spans multiple CCs of the set of multiple CCs and monitoring the multiple CCs within the sensing window, where the first candidate resource may be selected based on the monitoring.

Some examples of the method, apparatuses, and non-transitory computer-readable medium described herein may further include operations, features, means, or instructions for identifying one or more resources available for reservation within the set of multiple candidate resources based on performing the sensing within the sensing window, where the first candidate resource may be included in the one or more resources.

In some examples of the method, apparatuses, and non-transitory computer-readable medium described herein, identifying the resource selection configuration may include operations, features, means, or instructions for identifying the resource selection configuration that indicates an interference metric corresponding to a sidelink transmission gap and determining a respective interference measurement for each CC of the set of multiple CCs based on the interference metric and performing the sensing within the sensing window, where the first candidate resource may be selected based on the respective interference measurements.

In some examples of the method, apparatuses, and non-transitory computer-readable medium described herein, identifying the resource selection configuration may include operations, features, means, or instructions for identifying the resource selection configuration that indicates a sidelink channel occupancy metric and determining a respective sidelink channel occupancy measurement for each CC of the set of multiple CCs based on the sidelink channel occupancy metric and performing the sensing within the sensing window, where the first candidate resource may be selected based on the respective sidelink channel occupancy measurements.

Some examples of the method, apparatuses, and non-transitory computer-readable medium described herein may further include operations, features, means, or instructions for selecting a second candidate resource of the set of multiple candidate resources on a second CC of the set of multiple CCs based on performing the sensing within the sensing window, transmitting the first sidelink control message or a second sidelink control message indicating a carrier index of the second CC and a resource allocation corresponding to the second candidate resource, and communicating a second sidelink message within the second candidate resource of the shared radio frequency spectrum band using the second CC.

In some examples of the method, apparatuses, and non-transitory computer-readable medium described herein, the first CC may be different than the second CC.

### BRIEF DESCRIPTION OF THE DRAWINGS

FIG. 1 illustrates an example of a wireless communications system in accordance with aspects of the present disclosure.

FIG. 2 illustrates an example of a resource selection scheme in accordance with aspects of the present disclosure.

FIG. 3 illustrates an example of a wireless communications system in accordance with aspects of the present disclosure.

FIGS. 4A and 4B illustrate examples of carrier selection configurations in accordance with aspects of the present disclosure.

FIG. 5 illustrates an example of a resource selection scheme in accordance with aspects of the present disclosure.

FIG. 6 illustrates an example of a process flow in accordance with aspects of the present disclosure.

FIG. 7 illustrates an example of a resource selection scheme in accordance with aspects of the present disclosure.

FIG. 8 illustrates an example of a process flow in accordance with aspects of the present disclosure.

FIGS. 9 and 10 show block diagrams of devices in accordance with aspects of the present disclosure.

FIG. 11 shows a block diagram of a communications manager in accordance with aspects of the present disclosure.

FIG. 12 shows a diagram of a system including a device in accordance with aspects of the present disclosure.

FIGS. 13 through 16 show flowcharts illustrating methods in accordance with aspects of the present disclosure.

### DETAILED DESCRIPTION

Sidelink communications in unlicensed or shared spectrum may operate in a distributed manner (e.g., using autonomous resource allocation, such as mode 2 allocation). For such sidelink communications, a user equipment (UE) may monitor (e.g., and decode) sidelink communications (e.g., sidelink control information (SCI) and/or other transmissions) from other UEs that may indicate resources reserved by the other UEs. In some cases, there may be multiple component carriers (CCs) available for sidelink communication within unlicensed spectrum (e.g., within a shared spectrum band). For example, the unlicensed spectrum available for sidelink communication may be channelized to multiple CCs. In such cases, a UE receiving on the sidelink may monitor multiple CCs or all CCs available for sidelink communication. A UE transmitting on the sidelink may determine or select a CC for transmitting a sidelink message. Interference from other radio access technologies (RATs) in the unlicensed spectrum may limit an amount of resources available for resource selection by UEs, or may decrease overall communication quality within the unlicensed spectrum (e.g., via additional interference from the other RATs).

In order to increase probability of selecting a sidelink resource associated with a higher communication quality, UEs operating in unlicensed spectrum may be configured with a set of defined frequencies (e.g., a set of defined candidate CCs) for sidelink communications using the unlicensed spectrum (e.g., as defined by a wireless communications standard). For example, a UE may have the set of CCs stored (e.g., preconfigured) at the UE (e.g., based on the set of CCs being defined in a wireless communications standard), or the UE may receive an indication of the set of CCs from a base station (e.g., via radio resource control (RRC) signaling).

In a first example, a transmitting UE may select a carrier (e.g., a CC) from the set of candidate CCs and may select one or multiple resources in the selected CC for a sidelink communication (e.g., V2X communication). For example, the UE may use a carrier selection configuration to select a CC from the set of CCs, for transmitting a sidelink communication. The UE may select the CC for the sidelink communication based on a metric evaluated for each of the set of CCs over a defined time window (e.g., based on the carrier selection configuration), where the metric may be associated with a communication quality and may represent an interference level, congestion information, or sidelink communication information, among other examples. The transmitting UE may, for example, select the CC based on the CC being associated with a metric indicating higher communication quality (e.g., indicating lower interference in the CC). The UE may transmit a sidelink message using a resource of the selected CC in the unlicensed spectrum.

In a second example, a transmitting UE may select multiple resources for a sidelink communication (e.g., V2X communication), where the multiple resources may be in a same CC or in different CCs (e.g., of the set of CCs). For example, the UE may use a resource selection configuration to select a resource from any CC of the set of CCs for communicating a sidelink message. In one example, the UE may use the resource selection configuration to identify candidate resources across the set of CCs and may select one or more of the candidate resources. Candidate resources for resource selection may include all available resources in all the CCs of the set of CCs, resources in CCs associated with a lower interference level, or resources in candidate carriers associated with a sidelink channel occupancy reserving resources for sidelink transmissions (e.g., as determined based on sensing performed by the UE). In some cases, the UE may select multiple resources and may indicate (e.g., via SCI) one or multiple selected resources in future slots as reserved resources. In such cases, to indicate the reservation of a resource in a future slot, the transmitting UE may indicate both a carrier (e.g., CC) in which the reserved resource is located and a location of the reserved resource within the carrier. The UE may transmit a sidelink message using a selected candidate resource in the unlicensed spectrum.

Aspects of the disclosure are initially described in the context of wireless communications systems. Aspects of the disclosure are further illustrated by and described with reference to resource selection schemes, carrier selection configurations, process flows, apparatus diagrams, system diagrams, and flowcharts that relate to sidelink resource allocation in unlicensed spectrum.

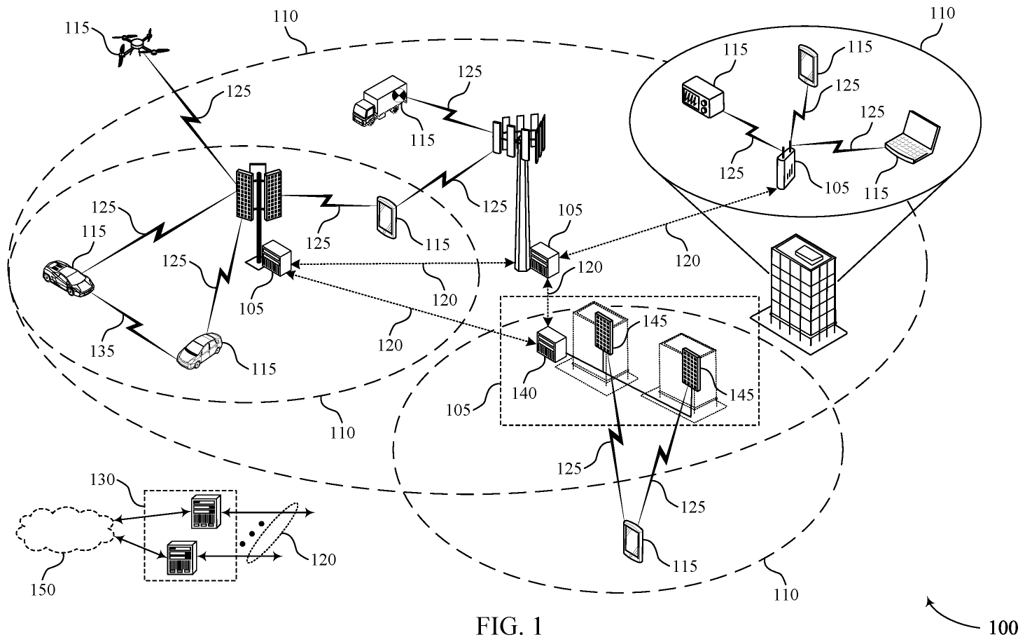

FIG. 1 illustrates an example of a wireless communications system 100 in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the least scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the least scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the medium access control (MAC) layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

UEs 115 operating in unlicensed spectrum may be configured with a set of defined frequencies (e.g., a set of defined candidate CCs) for sidelink communications using the unlicensed spectrum (e.g., as defined by a wireless communications standard). In a first example, a transmitting UE 115 may select a carrier (e.g., a CC) from the set of candidate CCs and may select one or multiple resources in the selected CC for a sidelink communication (e.g., V2X communication). The UE 115 may transmit a sidelink message using a resource of the selected CC in the unlicensed spectrum (e.g., in a shared radio frequency band). In a second example, a transmitting UE 115 may select multiple resources for a sidelink communication (e.g., V2X communication), where the multiple resources may be in a same CC or in different CCs (e.g., of the set of CCs). For example, the UE 115 may use a resource selection configuration to identify candidate resources across the set of CCs and may select one or more of the candidate resources. To indicate the reservation of a candidate resource, the transmitting UE 115 may indicate both a carrier (e.g., CC) in which the reserved resource is located and a location of the reserved resource within the carrier. The UE 115 may transmit a sidelink message using a selected candidate resource in the unlicensed spectrum.

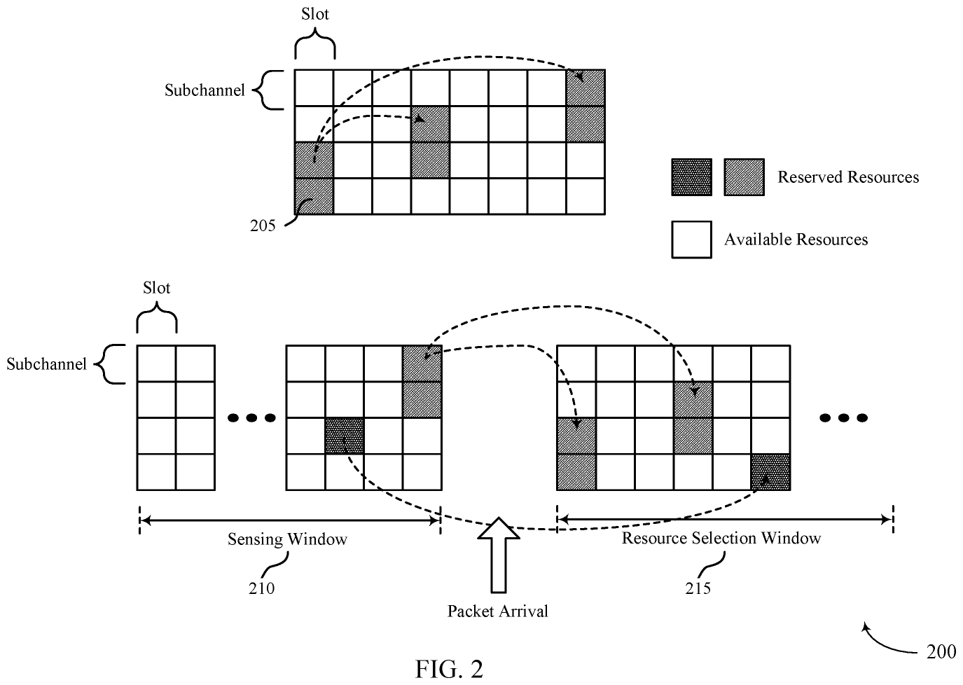

FIG. 2 illustrates an example of a resource selection scheme 200 in accordance with one or more aspects of the present disclosure. In some examples, resource selection scheme 200 may represent a selection scheme used by a first UE 115 to select sidelink resources for transmitting a sidelink message using unlicensed or shared spectrum. The first UE 115 may communicate with one or more second UEs 115 over a sidelink channel (e.g., in the unlicensed or shared spectrum). The first UE 115 and the one or more second UEs 115 described herein may each represent an example of a UE 115 described with reference to FIG. 1.

Some sidelink communications (e.g., V2X communications) may be designed to target deployment in a licensed spectrum (e.g., a licensed spectrum band), where the sidelink communications may either share the licensed spectrum in a licensed cellular band or may use a dedicated intelligent transportation system (ITS) spectrum. In a licensed cellular spectrum, the sidelink communications (e.g., V2X) may share an uplink spectrum in a cellular network, while a dedicated ITS spectrum may represent one or more spectrums around a frequency range (e.g., around 5.9 GHz) that may be allocated for sidelink communications (e.g., V2X), in some regions or countries.

In some cases, a dedicated spectrum for sidelink communications (e.g., V2X) may be scarce or unavailable (e.g., may not be guaranteed) in some regions, for example, based on a scarcity of spectrum. For example, in some areas or countries, there may be a dedicated spectrum allocated for first sidelink communications (e.g., LTE V2X), but limited spectrum (e.g., some or no spectrum) may be available for second sidelink communications (e.g., NR V2X, which may target V2X usage cases such as autonomous driving).

As such, some cellular sidelink communications (e.g., some cellular V2X communications) may be deployed in unlicensed spectrum, for example, based on being an only feasible option in some regions. Unlicensed spectrum may be shared with other communications technologies, such as Wi-Fi, and in some cases may be referred to as shared spectrum or a shared radio frequency spectrum band. A range of unlicensed spectrums may be available for sidelink communications, for example, from 5 GHz to 6 GHz. For example, unlicensed national information infrastructure (U-NII) bands may be available, such as U-NII-3 spectrum (e.g., from 5.725 GHz to 5.850 GHz) or U-NII-4 spectrum (e.g., from 5.850 GHz to 5.925 GHz), or spectrum at or above 6 GHz may be available.

In unlicensed spectrum, a minimum channel bandwidth may be specified, for example, following regional regulations (e.g., some regions may have a minimum channel bandwidth of 5 MHz). A device (e.g., a device using any technology) may transmit in a bandwidth (e.g., a minimum channel bandwidth) within unlicensed spectrum. For example, a device may transmit with a channel bandwidth of 20 MHz, 80 MHz, or 160 MHz, among other examples.

Some sidelink communications (e.g., NR V2X) may support autonomous resource allocation by UEs 115 (e.g., a mode 2 resource allocation). In such cases, a UE 115 (e.g., the first UE 115) may access a channel based on sensing outcomes. For example, the first UE 115 may identify available resources for a sidelink transmission (e.g., sidelink message), which may be referred to as candidate resources. The first UE 115 may select one or more resources 205 for the sidelink transmission from the candidate resources. A UE 115 may also reserve a number of future resources (e.g., in addition to the resource(s) 205) for the sidelink transmission, for example, for retransmission of a packet of the sidelink transmission. One or more first resources 205 for the sidelink transmission may identify or reserve the number of future resources for retransmission of the sidelink transmission (e.g., as indicated by the arrows in FIG. 2).

To identify available resources, the first UE 115 may monitor and decode some or all transmissions (e.g., SCI) from the one or more second UEs 115 and may perform a reference signal received power (RSRP) measurement for each of the decoded transmissions. When resource selection is triggered at the first UE 115 (e.g., a packet arrives for transmission from the first UE 115), the first UE 115 may determine a sensing window 210 (e.g., a window in the past) and may determine available resources based on SCI decoding and/or RSRP measurement in the sensing window 210. The first UE 115 may identify available resources in a resource selection window 215 (e.g., a window in the future) by projecting decoding and/or measurement outcomes from the sensing window to the resource selection window 215. For example, a resource in the resource selection window 215 may be considered available if the SCI (e.g., the SCI decoding outcomes) indicate no reservation of the resource in the resource selection window 215 or if the resource has been reserved but a measured RSRP projected to the resource is below an RSRP threshold. To select a resource for transmission, the first UE 115 may perform random resource selection from the available resources.

Accordingly, to perform autonomous resource allocation (e.g., mode 2 allocation), the first UE 115 may monitor sidelink transmissions and perform RSRP measurements and may perform resource selection when such selection is triggered (e.g., resource selection may be triggered by a packet arrival).

Channel access procedures may be performed before transmitting using unlicensed spectrum (e.g., NR unlicensed (NR-U)) and may, for example, include channel access types such as a type 1 channel access or a type 2 channel access. A type 1 channel access may, for example, include a random time duration spanned by sensing slots that are sensed by a UE 115 (e.g., the first UE 115) to be idle before one or more sidelink transmissions (e.g., which may be referred to as a category 4 (CAT 4) listen before talk (LBT) procedure). A type 2 channel access may include a deterministic time duration spanned by sensing slots that are sensed by a UE 115 (e.g., the first UE 115) to be idle before one or more sidelink transmissions. For example, a type 2A channel access may have a sensing duration of 25 microseconds (μs), a type 2B channel access may have a sensing duration of 16 μs, and a type 2C channel accessing may perform no sensing (e.g., which may be applied when a gap is no larger than 16 μs).

In some cases in NR-U, a base station 105 may initiate a channel occupancy (e.g., a channel occupancy time (COT)), for example, based on type 1 channel access. In some cases, a UE 115 (e.g., the first UE 115) may share the channel occupancy, where the UE 115 may perform type 2 channel access before one or more intended transmissions. In such cases, the UE 115 may transmit if the type 2 channel access is successful. For sidelink communications in unlicensed spectrum, a UE 115 may initiate a channel occupancy, for example, based on a type 1 channel access, where another UE 115 may share the channel occupancy (e.g., may transmit in the channel occupancy based on a type 2 channel access).

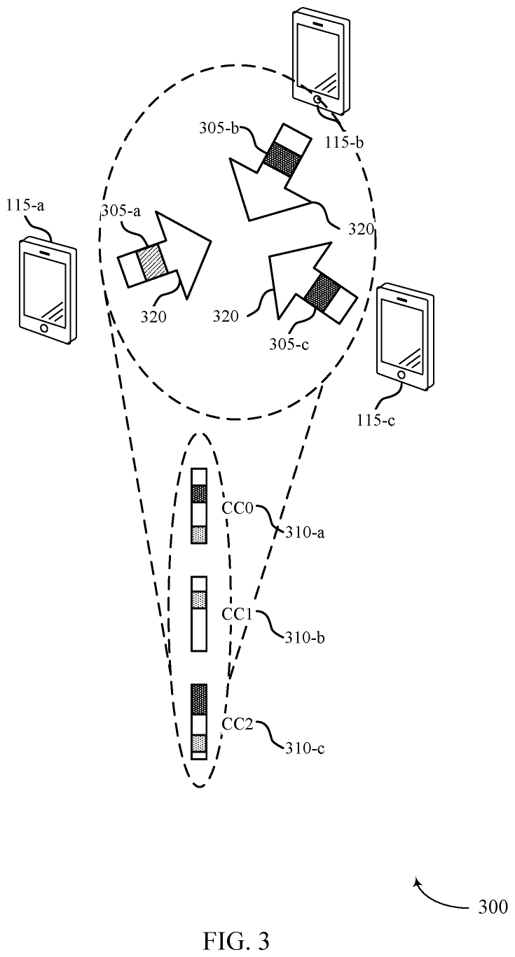

FIG. 3 illustrates an example of a wireless communications system 300 that supports sidelink resource selection in unlicensed spectrum in accordance with one or more aspects of the present disclosure. Wireless communications system 300 may implement or be implemented by aspects of wireless communications system 100 and/or resource selection scheme 200. Wireless communications system 300 may include UEs 115-a, 115-b, and 115-c (e.g., among other UEs 115), which may each represent an example of a UE 115 described with reference to FIGS. 1 and 2. UEs 115-a, 115-b, and 115-c may communicate with each other or with one or more other UEs 115 in unlicensed spectrum (e.g., shared spectrum) via sidelink communications 305 (e.g., V2X communications).

Sidelink communications 305 (e.g., cellular V2X) over a sidelink channel 320 in unlicensed spectrum may operate in a distributed manner (e.g., using autonomous resource allocation, such as mode 2 allocation). For example, UEs 115-a, 115-b, and 115-c may communicate on their own, without any central nodes (e.g., base stations 105) scheduling or assisting with the sidelink communications 305. For such sidelink communications, a UE 115 may monitor (e.g., and decode) sidelink communications 305 (e.g., SCI and/or other transmissions) from other UEs 115. For example, UE 115-a may monitor sidelink communications 305-b and 305-b from UEs 115-b and 115-c, respectively (e.g., among other sidelink communications 305). The UE 115 may monitor sidelink communications 305 when the UE 115 does not transmit, for example, such that the UE 115 may not miss sidelink messages (e.g., sidelink communications 305) from other UEs 115 (e.g., vehicles or pedestrians).

In some cases, there may be multiple carriers (e.g., CCs 310) available for sidelink communication within unlicensed spectrum (e.g., within a shared radio frequency spectrum band). In such cases, a UE 115 receiving on the sidelink may monitor multiple CCs 310 or all CCs 310 available for the sidelink communication (e.g., V2X communication). A UE 115 transmitting on the sidelink may determine or select a CC for transmitting a sidelink communication 305 (e.g., a sidelink transmission or a sidelink message).

Additionally, different UEs 115 may experience different communication quality (e.g., interference) on different CCs 310. For example, UE 115-b may experience higher interference in a first CC 310-a (e.g., CC0), while UE 115-c may experience higher interference in a second CC 310-b (e.g., CC1). In some cases, a transmitting UE 115 may transmit a sidelink communication 305 to multiple receiving UEs 115 in a selected CC 310 (e.g., sidelink broadcast or groupcast), where the receiving UEs 115 may experience different interference levels in the selected CC 310. For example, UE 115-a may transmit sidelink communication 305-a via CC0 to UEs 115-b and 115-c (e.g., among other UEs 115), where UE 115-b may experience a higher interference level in CC0 than an interference level experienced by UE 115-c, which may result in a lower communication quality for sidelink communication 305-a for UE 115-b.

The interference from other RATs in the unlicensed spectrum may limit an amount of resources available for resource selection by UEs 115-a, 115-b, and 115-c, or may decrease overall communication quality within the unlicensed spectrum (e.g., via additional interference from the other RATs). The other RATs may also, in some cases, decrease a probability of a successful sidelink channel access (e.g., V2X channel access) for transmission of a sidelink communication 305.

In order to increase probability of selecting an unoccupied sidelink resource associated with a higher communication quality, UEs 115 operating in unlicensed spectrum may be configured with a set of defined frequencies (e.g., a set of defined candidate CCs 310) for sidelink communications (e.g., V2X) using the unlicensed spectrum (e.g., as defined by a wireless communications standard). The set of frequencies may be channelized to a number of CCs (e.g., the set of candidate CCs), and each CC 310 may have a defined bandwidth (e.g., 20 MHz). In some examples, the set of candidate CCs may include a first CC 310-a (e.g., CC0), a second CC 310-b (e.g., CC1), and a third CC 310-c (e.g., CC2), among other CCs 310.

In a first example, a transmitting UE 115 (e.g., UE 115-a) may select a carrier (e.g., a CC 310) from the set of candidate CCs and may select one or multiple resources in the selected CC 310 for a sidelink communication 305 (e.g., V2X communication). For example, UE 115-a may use a carrier selection configuration to select a CC 310 from the set of CCs, for transmitting a sidelink communication 305-a. UE 115-a may be hard coded at the time of manufacture with the carrier selection configuration, for example, based on being coded to comply with a wireless standard. Additionally or alternatively, sidelink UEs 115 may coordinate with one another to identify a carrier selection configuration or a base station 105 may signal a UE 115 to indicate a carrier selection configuration to apply.

A receiving UE 115 (e.g., UEs 115-b and 115-c) may receive sidelink communications 305 in the unlicensed spectrum in one or multiple carriers (e.g., one or more selected CCs 310) from other UEs 115 (e.g., UE 115-a, among other UEs 115). The transmitting UE 115 may select the CC 310 for transmitting a sidelink communication 305 based on a metric evaluated for each of the set of CCs over a defined time window, where the metric may be associated with a communication quality and may represent an interference level, congestion information, or sidelink communication information, among other examples. The transmitting UE 115 may, for example, select the CC 310 based on the CC 310 being associated with a metric indicating higher communication quality (e.g., indicating lower interference in the CC 310).

In a second example, a transmitting UE 115 (e.g., UE 115-a) may select multiple resources for a sidelink communication 305 (e.g., V2X communication), where the multiple resources may be in a same CC 310 or in different CCs 310 (e.g., of the set of CCs). For example, UE 115-a may use a resource selection configuration to select one or multiple resources from any CC 310 of the set of CCs for communicating a sidelink message. UE 115-a may be hard coded at the time of manufacture with the resource selection configuration, for example, based on being coded to comply with a wireless standard. Additionally or alternatively, sidelink UEs 115 may coordinate with one another to identify a resource selection configuration or a base station 105 may signal a UE 115 to indicate a resource selection configuration to apply.

In one example, UE 115-a may use the resource selection configuration to identify candidate resources across the set of CCs and may select one or more of the candidate resources. Candidate resources for resource selection may include all available resources in all the CCs 310 or a subset of CCs 310 of the set of CCs, resources in CCs 310 associated with a lower interference level, or resources in candidate carriers associated with a sidelink channel occupancy reserving resources for sidelink transmissions.

In either the first or the second example described herein, a first resource of the selected resources may be used for an initial transmission of a transport block (TB) and any remaining selected resources may be used for retransmission of the TB. The transmitting UE 115 (e.g., UE 115-a) may indicate a resource reservation (e.g., for at least some of the selected resources). For example, when transmitting in a selected resource, the transmitting UE 115 may indicate (e.g., via SCI) one or multiple selected resources in future slots (e.g., transmission time occasions or TTIs) as reserved resources. In the second example described herein, to indicate the reservation of a resource in a future slot, the transmitting UE 115 may indicate both a carrier (e.g., CC 310) in which the reserved resource is located and a location of the reserved resource within the carrier. A receiving UE 115 (e.g., UEs 115-b and 115-c) may receive a sidelink communication 305 (e.g., sidelink communication 305-a) in unlicensed spectrum from other UEs 115 in one or multiple CCs 310.

The described techniques may increase utilization of resources within unlicensed spectrum (e.g., or other multi-carrier spectrum), for example, based on selection of a CC 310 or selection of resources across multiple CCs 310. The described techniques may additionally or alternatively decrease effects of other RATs (e.g., improve coexistence with other RATs) that may share the unlicensed spectrum (e.g., Wi-Fi), for example, based on techniques for determining which CC 310 or which resources to select. For example, selection of a CC 310 from the set of CCs (e.g., based on interference or other metrics) may increase distribution of sidelink (e.g., V2X) traffic to a CC 310 that has a lower (e.g., least) interference, which may decrease interference with other RATs and may improve sidelink communication performance.

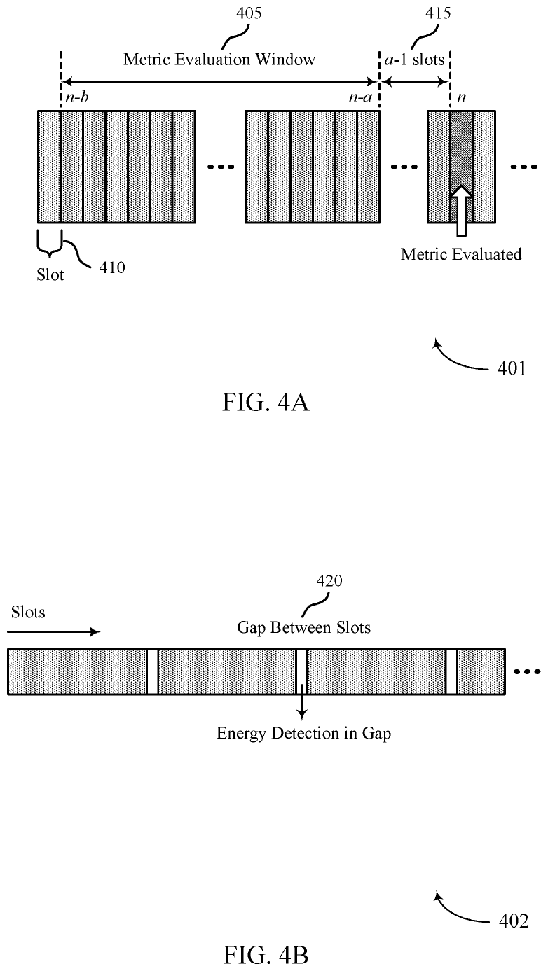

FIGS. 4A and 4B illustrate examples of carrier selection configurations 401 and 402 in accordance with aspects of the present disclosure. Carrier selection configurations 401 and 402 may implement or be implemented by aspects of wireless communications system 100 or 300. Some aspects of carrier selection configurations 401 and 402 may implement or be implemented by aspects of resource selection scheme 200. A first UE 115 may use one or more aspects of carrier selection configuration 401 and/or 402 to select a carrier (e.g., a CC) having resources for one or more sidelink messages (e.g., one or more sidelink communications as described with reference to FIG. 3), where the first UE 115 may represent an example of a UE 115 described with reference to FIGS. 1-3.

As described with reference to FIG. 3, the first UE 115 may select a carrier (e.g., a CC) from a set of candidate CCs configured for sidelink communication in unlicensed spectrum (e.g., shared spectrum). The first UE 115 may select one or multiple resources in the selected CC for transmission of a sidelink message (e.g., V2X message). For example, the first UE 115 may use carrier selection configuration 400 to select a CC from the set of CCs and transmit a sidelink message in one or more resources of the selected CC.

The carrier selection configuration 401 may indicate for the first UE 115 to monitor one or multiple metrics (e.g., a channel busy ratio (CBR), non-sidelink interference) in one candidate CC, multiple candidate CCs (e.g., of the set of candidate CCs), or all candidate CCs. The first UE 115 may monitor a metric in a time window 405 (e.g., a metric evaluation window), which may represent a sliding window. In some cases, a time window 405 may represent or include some aspects of a sensing window as described herein. For example, the first UE 115 may evaluate the metric in a slot 410 (e.g., a transmission time occasion in which carrier selection is triggered), which may be referred to as a slot n. The metric evaluated in slot n may reflect a situation in the time window 405 from slot n−b to slot n−a (e.g., where b>a≥1). The time window 405 may be based on a processing delay 415 (e.g., of a−1 slots) between an end of the time window 405 (e.g., slot n−a) and the evaluation of the metric (e.g., at slot n), where the processing delay 415 may represent a time taken by the first UE 115 to process or evaluate the metric (e.g., based on monitoring during the time window 405).

The monitoring of the metric may be performed independently in each CC, such that when evaluating the metric in multiple CCs, the first UE 115 may evaluate a metric in each CC independently (e.g., each monitored CC may have a sliding time window 405, and thus an evaluation for the metric). While the examples described herein may, in some cases, are described with reference to one metric and the evaluation thereof, it is to be understood that the same examples may also apply to evaluating multiple metrics without departing from the scope of the present disclosure.

In some examples, a metric for carrier selection may be an overall interference level in a respective CC (e.g., as measured by a received signal strength indicator (RSSI)). The overall interference may indicate an interference level in a monitored CC. The evaluated interference may capture all transmission activities in the CC (e.g., sidelink and non-sidelink transmissions in the evaluation window, such as sidelink and Wi-Fi transmissions). For example, the first UE 115 may measure a CBR in the evaluation window, which may indicate a ratio of slots, subchannels, or both, having an RSSI greater than an RSSI threshold. When CC selection is based on an overall interference metric, for example, a CC with a least or a lower interference level (e.g., smaller CBR) may be selected or prioritized for selection (e.g., a CC satisfying an interference criterion may be selected or prioritized).

In some examples, a metric for carrier selection may be a sidelink (e.g., V2X) congestion level in a respective CC. The sidelink congestion level may indicate sidelink (e.g., V2X) activity in a monitored CC, such that the evaluated congestion level may capture sidelink transmission activities in the CC (e.g., in the evaluation window). For example, the first UE 115 may measure a sidelink CBR, which may indicate a ratio of slots, subchannels, or both, having an RSSI greater than an RSSI threshold, for sidelink (e.g., V2X) slots of the evaluation window. The first UE 115 may, for example, employ one or more mechanisms for identifying sidelink slots in the evaluation window and may measure the sidelink CBR in the sidelink slots. When CC selection is based on a metric of a sidelink congestion level, a CC with a least or a lower interference level (e.g., lower sidelink CBR) may be selected or prioritized for selection (e.g., a CC satisfying an congestion criterion may be selected or prioritized).

In some examples, a metric for carrier selection may be a non-sidelink (e.g., non-V2X) interference level in a respective CC (e.g., detected energy or RSSI from Wi-Fi or a different RAT). The non-sidelink interference level may indicate non-sidelink (e.g., non-V2X) interference activity in a monitored CC. For example, the evaluated interference level may reflect non-sidelink transmission activities in the CC (e.g., in the evaluation window). The first UE 115 may evaluate the non-sidelink interference level by performing energy detection in a CC and determining whether the detected energy is below an energy detection threshold. When performing the energy detection in an evaluation window, the first UE 115 may perform the energy detection multiple times in the evaluation window (e.g., may perform energy detection in each slot or in a portion of the slots in the window).

In some cases, the metric for non-sidelink interference may be a ratio of energy detections in the window that indicate an energy detection higher than the threshold, or an average of energy detections in the window that indicate an energy detection higher than the threshold. The energy detection may be performed in an energy detection window that has no sidelink (e.g., V2X) transmissions, for example, in transmission gaps 420 between slots, as illustrated in FIG. 4B. When carrier selection is based on a metric of non-sidelink interference, a CC with a least or a lower interference level may be selected or prioritized for selection (e.g., a CC satisfying a non-sidelink interference criterion may be selected or prioritized).

In some examples, a metric for carrier selection may be a sidelink (e.g., V2X) resource reservation in a respective CC. In such cases, the evaluation window may be similar to or a same window as a sensing window for resource selection, for example, as described herein with reference to FIG. 2. For example, the carrier selection configuration 401 may indicate a resource reservation monitoring configuration for the first UE 115 to use to identify reserved resources, and the first UE 115 may monitor at least one resource on at least one of the set of CCs based on the resource reservation monitoring configuration. The sidelink channel sensing (e.g., SCI decoding and RSRP measurement) in the evaluation window or sensing window in a CC may, for example, indicate future resource reservations in a future resource selection window in the CC. A resource reservation metric may indicate how busy the future selection window would be (e.g., busy with sidelink transmissions from one or more second sidelink UEs 115), based on the sidelink channel sensing. When carrier selection is based on a metric of sidelink (e.g., V2X) resource reservation, a CC with a least amount of sidelink reservations (e.g., or most availability of resources) in a resource selection window may be selected or prioritized for selection (e.g., a CC satisfying a resource reservation criterion may be selected or prioritized).

In some examples, a metric for carrier selection may be a congestion control metric in a respective CC. In such cases, the evaluation window may be similar to or a same window as a CBR measurement window. The first UE 115 may, for example, evaluate a CBR or a channel occupancy ratio (e.g., a ratio of a total number of transmissions in the CC) in each evaluated CC. For a CC, the first UE 115 may check if transmission of its sidelink message would result in violation of a congestion control in the CC (e.g., if the channel occupancy ratio in a channel occupancy ratio evaluation window would exceed a channel occupancy ratio limit). If transmission of the sidelink message would not result in violation of the congestion control, the first UE 115 may select the CC or prioritize the CC for selection (e.g., a CC satisfying a congestion control criterion may be selected or prioritized). When carrier selection is based on congestion control, the congestion control metric may be used together with one or more other metrics. For example, the first UE 115 may first preclude CCs that fail to meet the congestion control requirement (e.g., that would result in a channel occupancy ration exceeding the limit), and the first UE 115 may select a CC from any remaining CCs based on the one or more other metrics (e.g., an interference level).

In some cases, carrier selection may be based on more than one of the metrics described herein (e.g., based on combinations of two or more metrics). For example, an evaluation of a first metric in multiple CCs may be the same or similar (e.g., a difference between the first metric in the multiple CCs may not exceed a difference threshold). In such cases, the carrier selection may be based on evaluation of a second metric. For example, the first metric may be an interference level and the second metric may be a number of sidelink (e.g., V2X) reservations in the resource selection window.

In some cases, carrier reselection (e.g., changing from a selected CC to another CC) may also be based on one of the metrics described herein (e.g., interference level, CBR, non-sidelink interference, resource reservation). For example, when a selected CC no longer meets a criterion corresponding to one of the metrics (e.g., or no longer has a highest or lowest criterion compared to other CCs), the first UE 115 may reselect a different CC (e.g., that meets the criterion or has a highest or lowest criterion). In one example, the selected CC may no longer have a lowest interference level, and the first UE 115 may reselect another CC that now has a lower interference level.

In some cases, the carrier selection configuration may include or be associate with a carrier reselection configuration that may indicate one or more metrics and/or a corresponding criterion for carrier reselection. In some cases, the carrier reselection configuration may indicate one or more other metrics for carrier reselection. For example, the first UE 115 may be hard coded at the time of manufacture with the carrier reselection configuration, for example, based on being coded to comply with a wireless standard. Additionally or alternatively, sidelink UEs 115 may coordinate with one another to identify a carrier reselection configuration or a base station 105 may signal the first UE 115 to indicate a carrier reselection configuration to apply.

In some cases, a metric for carrier selection or for carrier reselection may be statistical information of received HARQ feedbacks. For example, the metric may be a ratio of generated or received feedbacks that represent a negative acknowledgement (NACK), such that the metric may indicate a ratio of reception or transmission failures of the first UE 115 (e.g., in the evaluation window). In such cases, when the metric reaches a threshold, carrier reselection may be triggered. In some examples, the metric may be a ratio of generated HARQ feedbacks that represent a NACK, for example, based on the sidelink decoding outcomes of the first UE 115. Additionally or alternatively, the metric may represent a number of consecutive generated or received NACKs, such that carrier reselection may be triggered when a consecutive number of reception or transmission failures reaches a threshold.

In some examples, a metric for carrier selection or for carrier reselection may be statistical information of channel access (e.g., listen before talk (LBT) procedure) outcomes. For example, the metric may be a ratio of LBT failures, such that the metric may indicate the ratio of LBT failures of the first UE 115 (e.g., in the evaluation window). For example, if the first UE 115 has made ten LBT attempts but eight of them have failed, the ratio of LBT failures may be 0.8. When the metric reaches a threshold (e.g., 0.8), carrier reselection may be triggered. Additionally or alternatively, the metric may be a consecutive number of LBT failures, such that carrier reselection may be triggered when a consecutive number of LBT failures reaches a threshold.

In some examples, a metric for carrier selection or for carrier reselection may be a number (e.g., an average number) of transmissions or retransmissions of a same TB. For example, the metric may represent an average number of (re)transmissions of each TB. If the first UE 115 has transmitted a first number of TBs (e.g., M TBs, where M≥1) in the evaluation window and a total number of transmissions (e.g., in the evaluation window) is represented by a second number (e.g., N transmissions), each TB may have been transmitted, on average, N/M times. When the average (e.g., N/M) reaches a threshold, carrier reselection may be triggered. Additionally or alternatively, the metric may represent a number of (re)transmissions of a same TB. When the number of (re)transmissions of the TB reaches a threshold, carrier reselection may be triggered (e.g., similar to triggering reselection based on HARQ feedback).

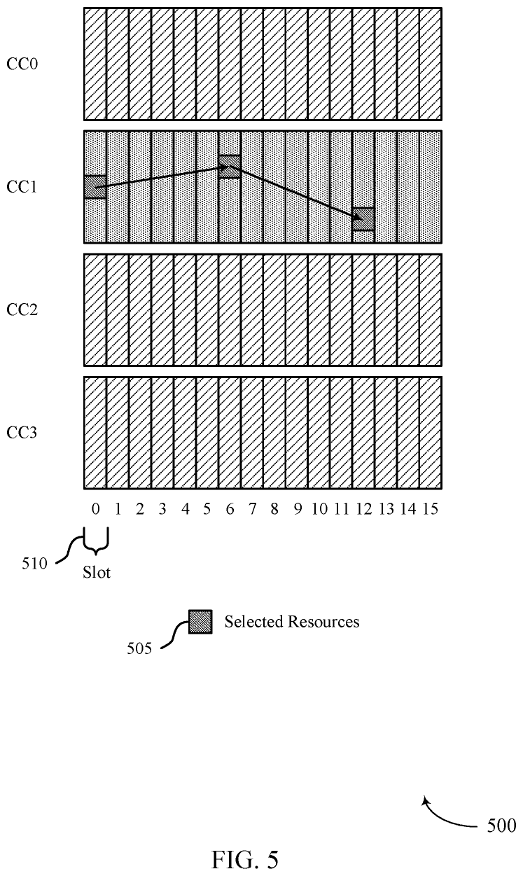

FIG. 5 illustrates an example of a resource selection scheme 500 in accordance with aspects of the present disclosure. Resource selection scheme 500 may implement or be implemented by aspects of wireless communications system 100 or 300. Some aspects of resource selection scheme 500 may implement or be implemented by aspects of resource selection scheme 200 or carrier selection configurations 401 or 402. A first UE 115 may use one or more aspects of resource selection scheme 500 to select resources in a selected carrier (e.g., a CC) for one or more sidelink messages (e.g., one or more sidelink communications as described with reference to FIG. 3), where the first UE 115 may represent an example of a UE 115 described with reference to FIGS. 1-4.

As described with reference to FIGS. 3 and 4, the first UE 115 may select a carrier (e.g., CC1) in an unlicensed spectrum (e.g., shared spectrum), and may use the carrier to select resources 505 for transmission of one or more sidelink messages. For example, the first UE 115 may select a CC from one of a CC0, CC1, CC2, or CC3 (e.g., among other examples). The first UE 115 may, for example, select one or multiple resources 505 within a selected CC (e.g., CC1) for transmission (e.g., an initial transmission and/or retransmission) of a sidelink message or TB. For example, the first UE 115 may select a resource 505 within one or multiple slots 510 (e.g., or other TTIs), where each combination of a slot 510 (e.g., a TTI) and a CC may represent a pool of resources that the first UE 115 may use for transmitting a sidelink message. When the first UE 115 selects multiple resources (e.g., multiple resources for an initial transmission and retransmission of a sidelink message or TB), the multiple resources may be located within a same CC (e.g., a selected CC). A first resource 505 of the multiple resources may be used for an initial transmission of a sidelink message or TB, and any remaining selected resources 505 may be used for one or more retransmissions of the sidelink message or TB.

The first UE 115 may indicate a resource reservation (e.g., for future selected resources). For example, when transmitting in a first selected resource 505 (e.g., in slot 0 and CC1), the first UE 115 may indicate (e.g., in control signaling of the current transmission) one or multiple selected resources 505 in future slots (e.g., in slot 6 or in slots 6 and 12, in CC1), for resource reservation. As such, a second transmitting UE 115 (e.g., sidelink UE 115) selecting a resource for a sidelink transmission may avoid selecting the reserved resources.

While a transmitting UE 115 (e.g., the first UE 115) may limit transmissions to a selected CC (e.g., CC1), a receiving UE 115 may not be limited to receive in one CC (e.g., because it may receive from multiple transmitting UEs 115, which may have selected different CCs). The first UE 115 may perform channel access (e.g., LBT) prior to the first slot (e.g., slot 0) including selected resources 505 and may perform the channel access before transmitting in the reserved resources (e.g., in slots 6 and 12), for example, to ensure the channel is clear from other RATs.

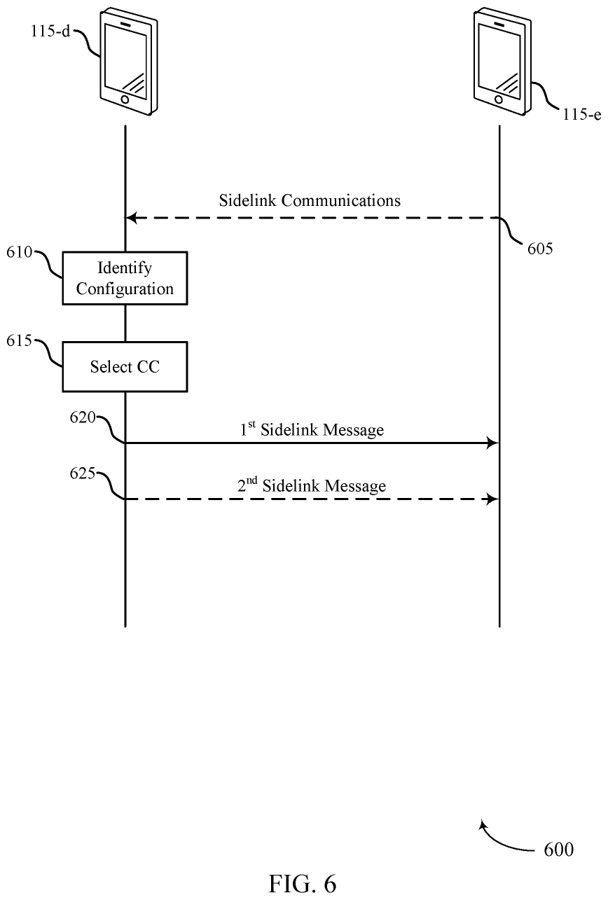

FIG. 6 illustrates an example of a process flow 600 in accordance with aspects of the present disclosure. In some examples, process flow 600 may implement or be implemented by aspects of wireless communications system 100 or 300. For example, process flow 600 may be implemented by UEs 115-d and 115-e, which may each represent an example of a UE 115 described with reference to FIGS. 1-5. Process flow 600 may be implemented by UEs 115-d and 115-e, for example, to select a CC having resources for a sidelink message using a set of candidate CCs, as described with reference to FIG. 3.

In the following description of process flow 600, the operations may be performed in a different order than the order shown, or the operations performed by UEs 115-d and 115-e may be performed in different orders or at different times. For example, specific operations may also be left out of process flow 600, or other operations may be added to process flow 600. Although UEs 115-d and 115-e are shown performing the operations of process flow 600, some aspects of some operations may also be performed by one or more other wireless devices.

At 605, UE 115-d may receive (e.g., from one or more other UEs 115, including UE 115-e) sidelink communications. The sidelink communications may include information (e.g., SCI) indicating resources reserved by other UEs 115 (e.g., UE 115-e) communicating on the sidelink. UE 115-d may receive the sidelink communications, may identify reserved or busy resources, and may use this information to select resources for a sidelink message. In some cases, UE 115-d may use the sidelink communications to evaluate a metric as described herein.

At 610, UE 115-d may identify a carrier selection configuration for selecting between a set of CCs for sidelink communications within a shared radio frequency spectrum band. For example, as described with reference to FIGS. 3, 4A, 4B, and 5, the carrier selection configuration may indicate the set of CCs and one or more carrier selection schemes for selecting or reselecting a CC from the set of CCs. The carrier selection configuration may, for example, indicate one or more metrics and a corresponding criterion for selecting a CC (e.g., indicate for UE 115-d to apply the one or more metrics and corresponding criterion for selecting a CC), as described herein with reference to FIGS. 3, 4A, 4B, and 5. The carrier selection configuration may also indicate which CCs (e.g., of the set of CCs) to monitor to evaluate the one or more metrics.

As described herein, UE 115-d may be hard coded at the time of manufacture with the carrier selection configuration, for example, based on being coded to comply with a wireless standard. Additionally or alternatively, UE 115-d may communicate with (e.g., signal to or receive signaling from) other sidelink UEs 115 (e.g., including UE 115-e) to indicate a carrier selection configuration to apply, or a base station 105 may signal UE 115-d to indicate a carrier selection configuration to apply.

At 615, UE 115-d may select a first CC of the set of CCs (e.g., for communicating a sidelink message) in accordance with the carrier selection configuration. For example, UE 115-d may select the CC using the one or more metrics and corresponding criterion.

At 620, UE 115-d may communicate (e.g., broadcast or groupcast to UE 115-e and other UEs 115) a first sidelink message (e.g., a first transmission of a sidelink message or TB) within a first resource of the shared radio frequency spectrum band using the first CC. As described herein, UE 115-d may transmit the first sidelink message on the first CC (e.g., the selected CC) of the set of CCs, using a resource selected within the first CC.

At 625, in some cases, UE 115-d may communicate (e.g., broadcast or groupcast to UE 115-e and other UEs 115) a second sidelink message (e.g., a retransmission of the first sidelink message or TB). In a first example, the second sidelink message may be communicated within a second resource of the shared radio frequency spectrum band using the first CC. In such cases, UE 115-d may indicate the second resource using the first sidelink message (e.g., using a corresponding SCI), for example, to reserve the second resource. In a second example, the second sidelink message may be communicated within a second resource of the shared radio frequency spectrum band using a second CC. The second CC may be selected, for example, as part of a carrier reselection performed in accordance with a carrier reselection configuration (e.g., using a corresponding metric).

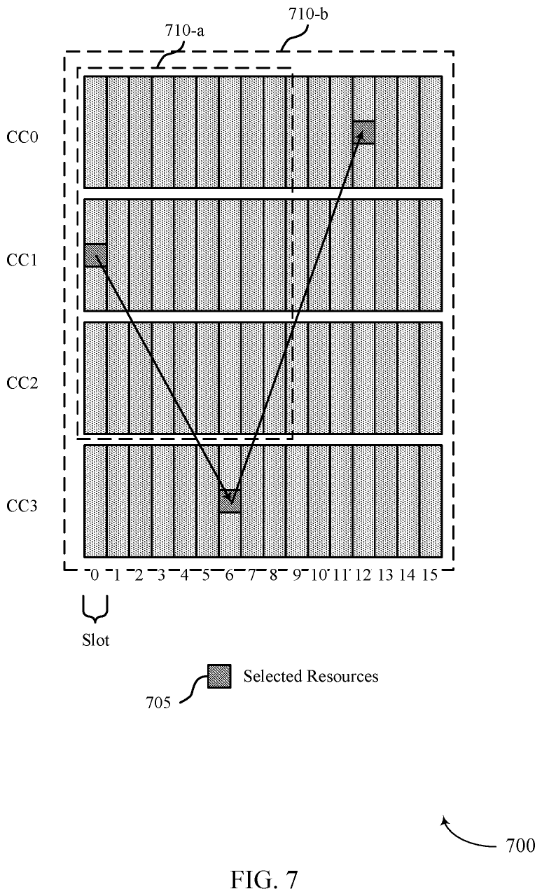

FIG. 7 illustrates an example of a resource selection scheme 700 in accordance with aspects of the present disclosure. Resource selection scheme 700 may implement or be implemented by aspects of wireless communications system 100 or 300. Some aspects of resource selection scheme 700 may implement or be implemented by aspects of resource selection scheme 200. A first UE 115 may use one or more aspects of resource selection scheme 700 to select resources across multiple carriers (e.g., multiple CCs) for one or more sidelink messages (e.g., one or more sidelink communications as described with reference to FIG. 3), where the first UE 115 may represent an example of a UE 115 described with reference to FIGS. 1-6.

As described with reference to FIG. 3, the first UE 115 may select multiple resources for a sidelink message (e.g., V2X message or TB), where the multiple resources may be in a same CC or in different CCs (e.g., of a set of candidate CCs). For example, the first UE 115 may use resource selection scheme 700 to select a resource from any CC of the set of CCs for communicating a sidelink message, where the set of CCs may include a CC0, CC1, CC2, or CC3 (e.g., among other examples). In one example, the first UE 115 may use the resource selection scheme 700 to identify candidate resources across the set of CCs and may select one or more of the candidate resources. For example, the first UE 115 may select a resource 705 within one or multiple slots (e.g., or other TTIs) and one or multiple CCs, where each combination of a slot (e.g., a TTI) and a CC may represent a pool of resources that the first UE 115 may use for transmitting a sidelink message.

The first UE 115 may, for example, perform sensing in a sensing window (e.g., to identify candidate resources and select one or more resources), where the sensing window may be or represent a sliding window. The sensing window may represent a two-dimensional window and may extend a duration of time in a time dimension and a frequency range in a frequency dimension. The sensing window may span multiple CCs in frequency, such as all or part of the set of candidate CCs. In some examples, the sensing window may be represented by a sensing window 710-a or 710-b, among other examples. The sensing performed during the sensing window may be based on SCI decoding, RSRP measurement, and/or interference measurement (e.g., non-sidelink activity).

The first UE 115 may identify, based on the sensing, whether a resource in a resource selection window is busy (e.g., reserved). If a resource is not busy, the resource may be counted as an available resource (e.g., for resource selection). The first UE 115 may additionally or alternatively identify, based on the sensing, whether there is an active sidelink (e.g., V2X) channel occupancy (e.g., or COT) in a CC of the set of CCs, and may further identify a non-sidelink (e.g., non-V2X) interference level in a CC of the set of CCs.

The first UE 115 may select one or multiple resources 705 from the identified candidate resources (e.g., identified based on the sensing). Resource selection may be performed in a resource selection window (e.g., as described with reference to FIG. 2) and may span multiple CCs (e.g., same CCs spanned by the sensing window). In a first example, the first UE 115 may select resources from all of the candidate resources. For example, all of the available resources within the resource selection window may be counted as candidate resources, and the first UE 115 may randomly select one or multiple resources 705 from the candidate resources.

In a second example, the first UE 115 may preclude (e.g., exclude or deprioritize) available resources in CCs that experience higher (e.g., more severe) non-sidelink interference (e.g., non-V2X interference). For example, some CCs evaluated by the first UE 115 may observe higher non-sidelink interference (e.g., more sever interference compared to other CCs), such as in a CC heavily occupied by Wi-Fi transmissions. The non-sidelink interference may be measured or evaluated in the sensing window as described herein. The first UE 115 may preclude resources in a CC (e.g., all resources in the CC) that has higher non-sidelink interference (e.g., an interference metric may exceed a threshold). For example, resources in CC2 may be precluded based on non-sidelink interference in CC2. In some cases, a non-sidelink interference metric may be a ratio of slots that are occupied by non-sidelink transmissions in the sensing window, which may be evaluated per CC (e.g., evaluated individually for each CC). Any remaining available resources (e.g., non-precluded resources in other CCs) may be counted as candidate resources, and the first UE 115 may select one or multiple resources 705 from the candidate resources.

In a third example, the first UE 115 may preclude (e.g., exclude or deprioritize) available resources in CCs that do not have a sidelink channel occupancy (e.g., V2X channel occupancy) in the resource selection window. In some examples, a CC (e.g., one or more CCs, such as CC0, CC1, and CC3) of the set of CCs may have a channel occupancy initiated by a sidelink UE. The first UE 115 may preclude available resources in CCs that do not have a sidelink channel occupancy in the resource selection window (e.g., as determined based on detecting a channel occupancy during the sensing). For example, resources in CC2 may be precluded based on CC2 not having a sidelink channel occupancy. Any remaining available resources (e.g., non-precluded resources in other CCs) may be counted as candidate resources, and the first UE 115 may select one or multiple resources 705 from the candidate resources.

In some cases, the first UE 115 may reserve one or more resources in future slots (e.g., future transmission time occasions). When transmitting in a selected resource (e.g., in a slot 0 and CC1), the first UE 115 may indicate one or multiple selected resources 705 in future slots, as reserved resource(s). For example, when transmitting in slot 0 and CC1, the first UE 115 may indicate reserved resources in slot 6 and CC3 and in some cases, may also indicate reserved resources in slot 12 and CC0. In some cases, when transmitting in slot 6 and CC3, the first UE 115 may indicate reserved resources in slot 12 and CC0. The reservation signaling may, for example, be carried in SCI. The reservation may indicate the CC in which the reserved resource(s) is located (e.g., CC3 and/or CC0), as well as a time and frequency location of the reserved resource in the CC. In some cases, a transmission (e.g., SCI) may indicate reservations for multiple future resources and may therefore, in some cases, indicate a respective CC and a respective frequency and time location for each reserved resource. Each CC may have an index (e.g., greater than or equal to zero), and the indication of a CC associated with a reserved resource may be based on (e.g., may indicate) the corresponding index.

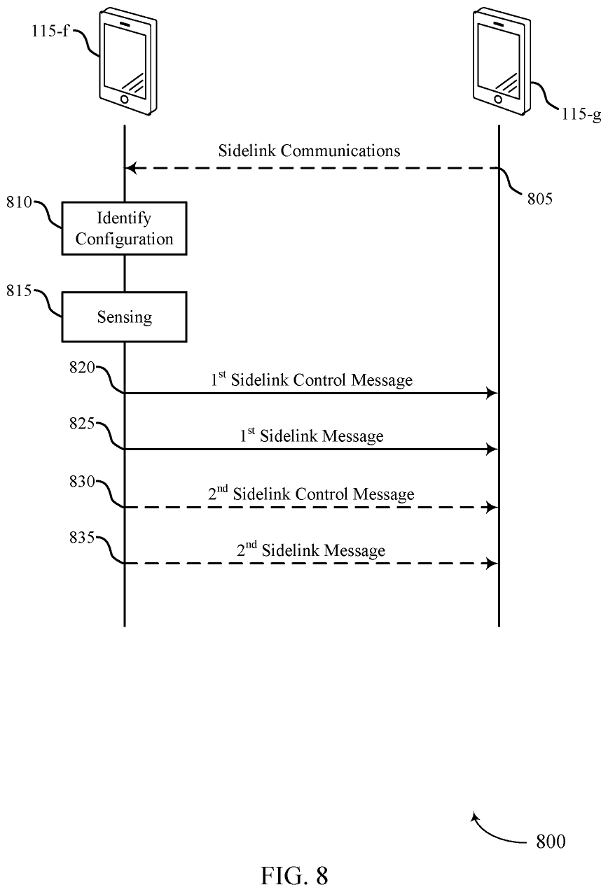

FIG. 8 illustrates an example of a process flow 800 in accordance with aspects of the present disclosure. In some examples, process flow 800 may implement or be implemented by aspects of wireless communications system 100 or 300. For example, process flow 800 may be implemented by UEs 115-f and 115-g, which may each represent an example of a UE 115 described with reference to FIGS. 1-7. Process flow 800 may be implemented by UEs 115-f and 115-g, for example, to select a resource (e.g., from candidate resources) for a sidelink message across a set of candidate CCs, as described with reference to FIG. 3.

In the following description of process flow 800, the operations may be performed in a different order than the order shown, or the operations performed by UEs 115-f and 115-g may be performed in different orders or at different times. For example, specific operations may also be left out of process flow 800, or other operations may be added to process flow 800. Although UEs 115-f and 115-g are shown performing the operations of process flow 800, some aspects of some operations may also be performed by one or more other wireless devices.

At 805, UE 115-f may receive (e.g., from one or more other UEs 115, including UE 115-g) sidelink communications. The sidelink communications may include information (e.g., SCI) indicating resources reserved by other UEs 115 (e.g., UE 115-g) communicating on the sidelink. UE 115-f may receive the sidelink communications, may identify reserved or busy resources, and may use this information to select resources for a sidelink message. In some cases, UE 115-f may use the sidelink communications to identify candidate resources as described herein.

At 810, UE 115-f may identify a resource selection configuration for resource selection between a set of candidate resources of a set of CCs for sidelink communications within a shared radio frequency spectrum band. For example, as described with reference to FIGS. 3 and 7, the resource selection configuration may indicate the set of CCs and one or more resource selection schemes for selecting or identifying candidate resources from the set of CCs (e.g., may indicate for UE 115-f to apply the one or more options for identifying candidate resources). For example, the resource selection configuration may indicate a scheme for identifying candidate resources across the set of CCs, as described herein with reference FIGS. 3 and 7.

As described herein, UE 115-f may be hard coded at the time of manufacture with the resource selection configuration, for example, based on being coded to comply with a wireless standard. Additionally or alternatively, UE 115-f may communicate with (e.g., signal to or receive signaling from) other sidelink UEs 115 (e.g., including UE 115-g) to indicate a resource selection configuration to apply, or a base station 105 may signal UE 115-f to indicate a resource selection configuration to apply.

At 815, UE 115-f may perform sensing within a sensing window for selecting a first candidate resource of the set of candidate resources on a first CC of the set of CCs based on the resource selection configuration. For example, UE 115-f may perform sensing to identify candidate resources, which may include all available resources of the set of CCs or which may exclude resources on a CC with a higher non-sidelink interference level or which does not have a sidelink channel occupancy.

At 820, UE 115-f may transmit (e.g., broadcast or groupcast to UE 115-g and other UEs 115) a first sidelink control message indicating a carrier index of the first CC and a resource allocation corresponding to the first candidate resource. As described herein, the first sidelink control message (e.g., SCI) may indicate a resource allocation that indicates a time location, frequency location, or both, of the first candidate resource. As described herein, the resource allocation may indicate, for the first candidate resource, one or more resource elements, one or more resource blocks, a BWP, a subchannel, a frequency band within a carrier bandwidth, a carrier index, a frequency index, a slot index, or any combination thereof (e.g., among other examples). In some cases, the first sidelink control message may indicate a resource for one or more second sidelink messages (e.g., a reserved resource for a future transmission).

At 825, UE 115-f may communicate (e.g., broadcast or groupcast to UE 115-g and other UEs 115) a first sidelink message (e.g., a first transmission of a sidelink message or TB) within the first candidate resource of the shared radio frequency spectrum band using the first CC.

At 830, in some cases, UE 115-f may transmit (e.g., broadcast or groupcast to UE 115-g and other UEs 115) a second sidelink control message. For example, UE 115-f may reserve a second candidate resource (e.g., a selected candidate resource) for the second sidelink control message in the first CC or in a second CC. UE 115-f may transmit the second sidelink control message indicating a carrier index of the second CC or the first CC and a resource allocation corresponding to the second candidate resource.

At 835, in some cases, UE 115-f may transmit (e.g., broadcast or groupcast to UE 115-g and other UEs 115) a second sidelink message (e.g., a retransmission of the first sidelink message or TB) within the second candidate resource of the shared radio frequency spectrum band using the first CC or the second CC. For example, the second sidelink message may be transmitted on the second candidate resource reserved by the first sidelink control message or the second sidelink control message (e.g., after a successful channel access procedure).

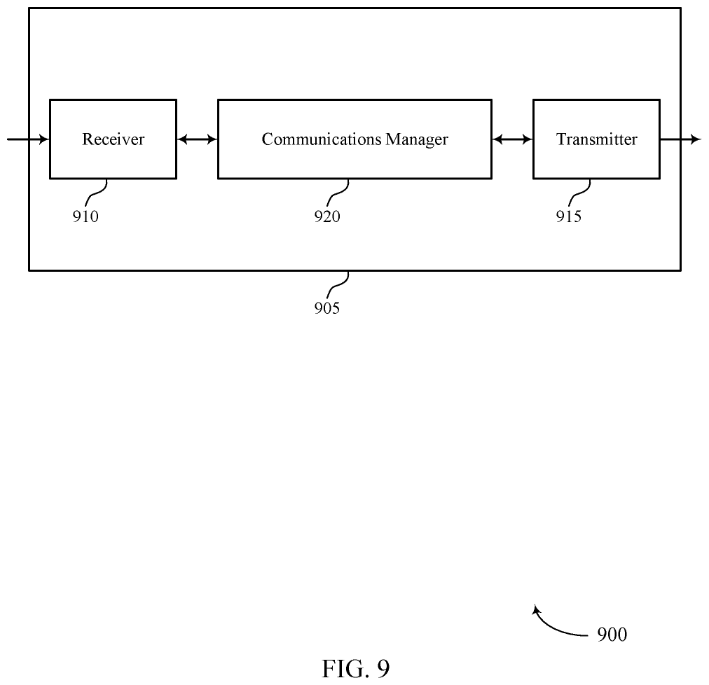

FIG. 9 shows a block diagram 900 of a device 905 in accordance with aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to sidelink resource allocation in unlicensed spectrum). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to sidelink resource allocation in unlicensed spectrum). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of sidelink resource allocation in unlicensed spectrum as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a UE in accordance with examples as disclosed herein. For example, the communications manager 920 may be configured as or otherwise support a means for identifying a carrier selection configuration for selecting between a set of multiple CCs for sidelink communications within a shared radio frequency spectrum band. The communications manager 920 may be configured as or otherwise support a means for selecting a first CC of the set of multiple CCs in accordance with the carrier selection configuration. The communications manager 920 may be configured as or otherwise support a means for communicating a first sidelink message within a first resource of the shared radio frequency spectrum band using the first CC.

Additionally or alternatively, the communications manager 920 may support wireless communication at a UE in accordance with examples as disclosed herein. For example, the communications manager 920 may be configured as or otherwise support a means for identifying a resource selection configuration for resource selection between a set of multiple candidate resources of a set of multiple CCs for sidelink communications within a shared radio frequency spectrum band. The communications manager 920 may be configured as or otherwise support a means for performing sensing within a sensing window for selecting a first candidate resource of the set of multiple candidate resources on a first CC of the set of multiple CCs based on the resource selection configuration. The communications manager 920 may be configured as or otherwise support a means for transmitting a first sidelink control message indicating a carrier index of the first CC and a resource allocation corresponding to the first candidate resource. The communications manager 920 may be configured as or otherwise support a means for communicating a first sidelink message within the first candidate resource of the shared radio frequency spectrum band using the first CC.

The actions performed by the communications manager 920, among other examples herein, may be implemented to realize one or more potential advantages. For example, communications manager 920 may increase available battery power and communication quality at a wireless device (e.g., a UE 115) by supporting selection of a CC for a sidelink transmission or selection of sidelink resources across multiple CCs. The increase in communication quality may result in increased link performance and decreased overhead based on the selected CC or sidelink resources. Accordingly, communications manager 920 may save power and increase battery life at a wireless device (e.g., a UE 115) by strategically increasing a quality of communications at a wireless device (e.g., a UE 115).

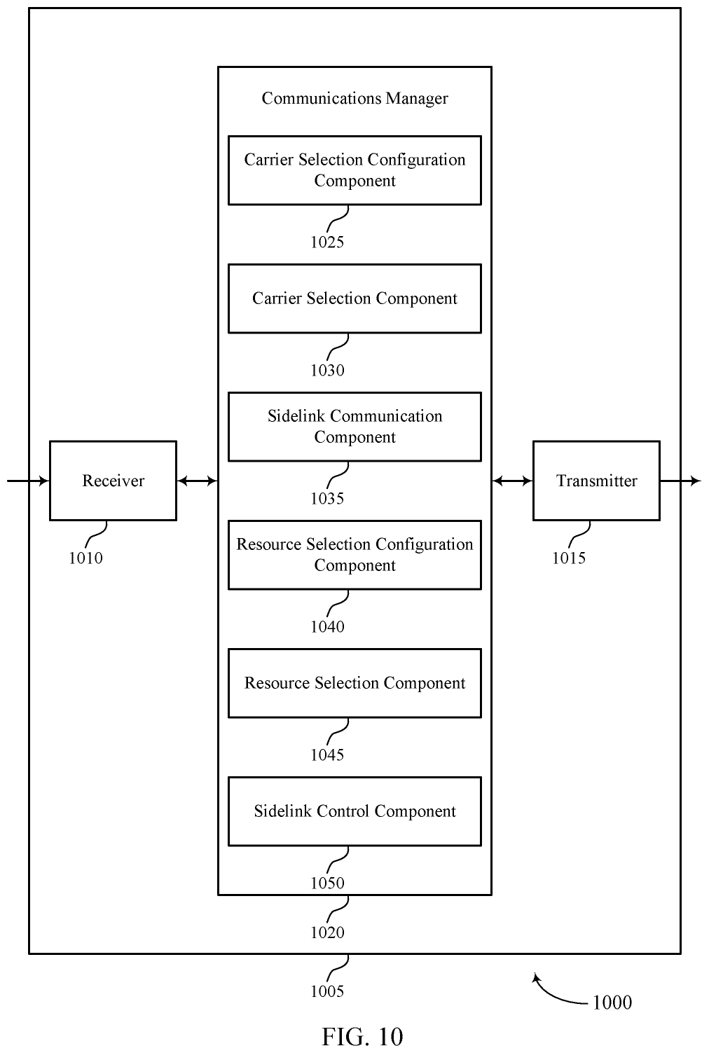

FIG. 10 shows a block diagram 1000 of a device 1005 in accordance with aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to sidelink resource allocation in unlicensed spectrum). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to sidelink resource allocation in unlicensed spectrum). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of sidelink resource allocation in unlicensed spectrum as described herein. For example, the communications manager 1020 may include a carrier selection configuration component 1025, a carrier selection component 1030, a sidelink communication component 1035, a resource selection configuration component 1040, a resource selection component 1045, a sidelink control component 1050, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a UE in accordance with examples as disclosed herein. The carrier selection configuration component 1025 may be configured as or otherwise support a means for identifying a carrier selection configuration for selecting between a set of multiple CCs for sidelink communications within a shared radio frequency spectrum band. The carrier selection component 1030 may be configured as or otherwise support a means for selecting a first CC of the set of multiple CCs in accordance with the carrier selection configuration. The sidelink communication component 1035 may be configured as or otherwise support a means for communicating a first sidelink message within a first resource of the shared radio frequency spectrum band using the first CC.

Additionally or alternatively, the communications manager 1020 may support wireless communication at a UE in accordance with examples as disclosed herein. The resource selection configuration component 1040 may be configured as or otherwise support a means for identifying a resource selection configuration for resource selection between a set of multiple candidate resources of a set of multiple CCs for sidelink communications within a shared radio frequency spectrum band. The resource selection component 1045 may be configured as or otherwise support a means for performing sensing within a sensing window for selecting a first candidate resource of the set of multiple candidate resources on a first CC of the set of multiple CCs based on the resource selection configuration. The sidelink control component 1050 may be configured as or otherwise support a means for transmitting a first sidelink control message indicating a carrier index of the first CC and a resource allocation corresponding to the first candidate resource. The sidelink communication component 1035 may be configured as or otherwise support a means for communicating a first sidelink message within the first candidate resource of the shared radio frequency spectrum band using the first CC.

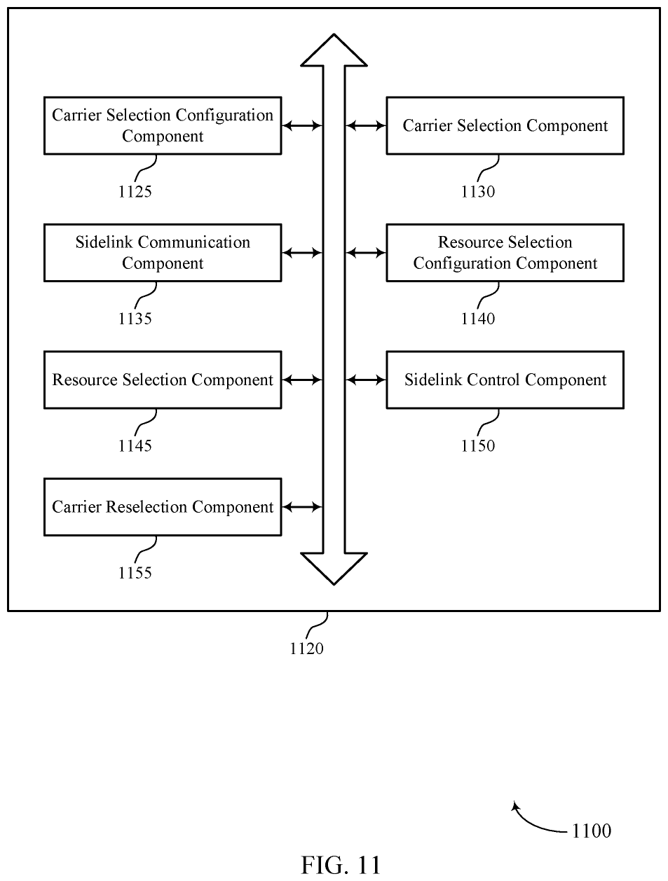

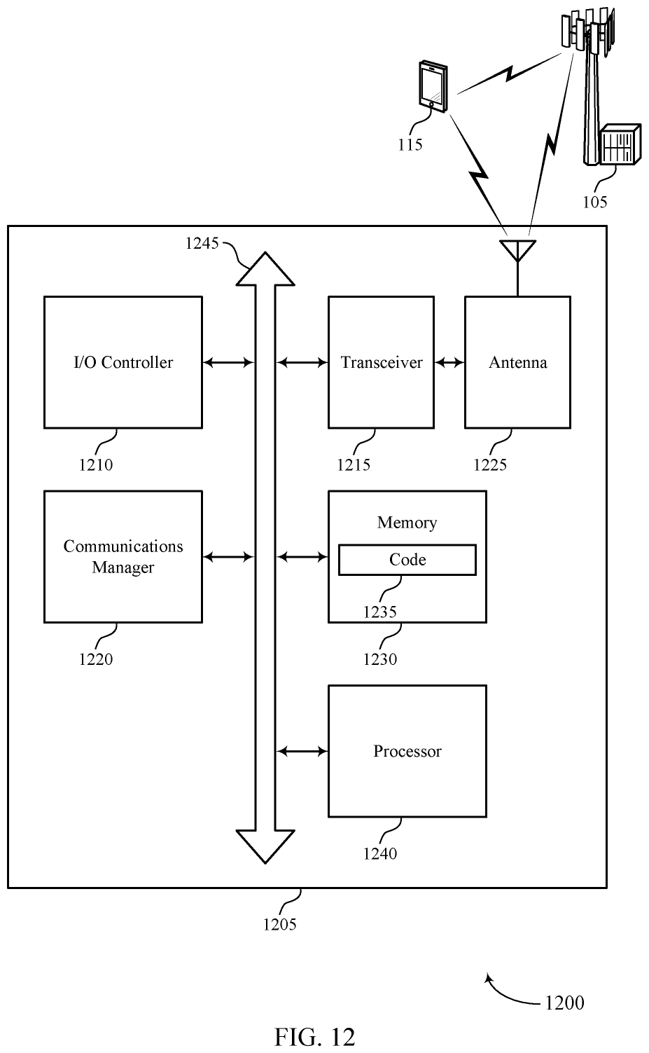

A processor of a wireless device (e.g., controlling the receiver 1010, the transmitter 1015, or the transceiver 1215 as described with reference to FIG. 12) may increase available battery power and communication quality. The increased communication quality may increase available battery power and throughput (e.g., via implementation of system components described with reference to FIG. 11) compared to other systems and techniques, for example, that do not support CC selection or sidelink resource selection across multiple CCs, which may decrease communication quality and increase power consumption. Further, the processor of the wireless device may identify one or more aspects of a carrier selection configuration or a resource selection configuration to perform the CC selection or sidelink resource selection. The processor of the wireless device may use the carrier selection configuration or resource selection configuration to perform one or more actions that may result in increased communication quality, as well as save power and increase battery life at the wireless device (e.g., by strategically supporting increased communication quality by using the selected CC or sidelink resources), among other benefits.

FIG. 11 shows a block diagram 1100 of a communications manager 1120 in accordance with aspects of the present disclosure. The communications manager 1120 may be an example of aspects of a communications manager 920, a communications manager 1020, or both, as described herein. The communications manager 1120, or various components thereof, may be an example of means for performing various aspects of sidelink resource allocation in unlicensed spectrum as described herein. For example, the communications manager 1120 may include a carrier selection configuration component 1125, a carrier selection component 1130, a sidelink communication component 1135, a resource selection configuration component 1140, a resource selection component 1145, a sidelink control component 1150, a carrier reselection component 1155, or any combination thereof. Each of these components may communicate, directly or indirectly, with one another (e.g., via one or more buses).

The communications manager 1120 may support wireless communication at a UE in accordance with examples as disclosed herein. The carrier selection configuration component 1125 may be configured as or otherwise support a means for identifying a carrier selection configuration for selecting between a set of multiple CCs for sidelink communications within a shared radio frequency spectrum band. The carrier selection component 1130 may be configured as or otherwise support a means for selecting a first CC of the set of multiple CCs in accordance with the carrier selection configuration. The sidelink communication component 1135 may be configured as or otherwise support a means for communicating a first sidelink message within a first resource of the shared radio frequency spectrum band using the first CC.

In some examples, to support identifying the carrier selection configuration, the carrier selection configuration component 1125 may be configured as or otherwise support a means for identifying the carrier selection configuration that indicates a channel metric, where the first CC is selected based on the channel metric.

In some examples, to support identifying the carrier selection configuration, the carrier selection configuration component 1125 may be configured as or otherwise support a means for identifying the carrier selection configuration that indicates a time window and a channel metric. In some examples, to support identifying the carrier selection configuration, the carrier selection component 1130 may be configured as or otherwise support a means for monitoring the set of multiple CCs within the time window based on the channel metric, where the first CC is selected based on the monitoring.

In some examples, to support identifying the carrier selection configuration, the carrier selection configuration component 1125 may be configured as or otherwise support a means for identifying the carrier selection configuration that indicates an interference metric. In some examples, to support identifying the carrier selection configuration, the carrier selection component 1130 may be configured as or otherwise support a means for monitoring the set of multiple CCs based on the interference metric, where the first CC is selected based on the monitoring indicating that the first CC satisfies an interference criterion associated with the interference metric.

In some examples, to support identifying the carrier selection configuration, the carrier selection configuration component 1125 may be configured as or otherwise support a means for identifying the carrier selection configuration that indicates a sidelink congestion metric. In some examples, to support identifying the carrier selection configuration, the carrier selection component 1130 may be configured as or otherwise support a means for monitoring the set of multiple CCs based on the sidelink congestion metric, where the first CC is selected based on the monitoring indicating that the first CC satisfies a congestion criterion associated with the sidelink congestion metric.

In some examples, to support identifying the carrier selection configuration, the carrier selection configuration component 1125 may be configured as or otherwise support a means for identifying the carrier selection configuration that indicates an interference metric corresponding to a sidelink transmission gap. In some examples, to support identifying the carrier selection configuration, the carrier selection component 1130 may be configured as or otherwise support a means for monitoring the set of multiple CCs within the sidelink transmission gap based on the interference metric, where the first CC is selected based on the monitoring indicating that the first CC satisfies an interference criterion associated with the interference metric for the sidelink transmission gap.

In some examples, to support identifying the carrier selection configuration, the carrier selection configuration component 1125 may be configured as or otherwise support a means for identifying the carrier selection configuration that indicates a resource reservation monitoring configuration. In some examples, to support identifying the carrier selection configuration, the carrier selection component 1130 may be configured as or otherwise support a means for monitoring at least one resource on at least one of the set of multiple CCs based on the resource reservation monitoring configuration, where the first CC is selected based on the monitoring indicating that the at least one resource on the at least one of the set of multiple CCs satisfies a resource reservation criterion.

In some examples, to support identifying the carrier selection configuration, the carrier selection configuration component 1125 may be configured as or otherwise support a means for identifying the carrier selection configuration that indicates a congestion control metric. In some examples, to support identifying the carrier selection configuration, the carrier selection component 1130 may be configured as or otherwise support a means for monitoring the set of multiple CCs based on the congestion control metric, where the first CC is selected based on the monitoring indicating that the first CC satisfies a congestion control criterion associated with the congestion control metric.

In some examples, the carrier reselection component 1155 may be configured as or otherwise support a means for identifying a carrier reselection configuration associated with the carrier selection configuration. In some examples, the carrier reselection component 1155 may be configured as or otherwise support a means for monitoring the set of multiple CCs to select a second CC based on the carrier reselection configuration. In some examples, the sidelink communication component 1135 may be configured as or otherwise support a means for communicating a second sidelink message within a second resource of the shared radio frequency spectrum band using the second CC.

In some examples, the carrier selection component 1130 may be configured as or otherwise support a means for selecting the first resource and a second resource of the shared radio frequency spectrum band corresponding to the first CC, where the first sidelink message indicates the second resource.

In some examples, to support identifying the carrier selection configuration, the carrier selection configuration component 1125 may be configured as or otherwise support a means for identifying the carrier selection configuration that indicates a set of multiple metrics. In some examples, to support identifying the carrier selection configuration, the carrier selection component 1130 may be configured as or otherwise support a means for monitoring the set of multiple CCs based on the set of multiple metrics, where the first CC is selected based on the monitoring.

Additionally or alternatively, the communications manager 1120 may support wireless communication at a UE in accordance with examples as disclosed herein. The resource selection configuration component 1140 may be configured as or otherwise support a means for identifying a resource selection configuration for resource selection between a set of multiple candidate resources of a set of multiple CCs for sidelink communications within a shared radio frequency spectrum band. The resource selection component 1145 may be configured as or otherwise support a means for performing sensing within a sensing window for selecting a first candidate resource of the set of multiple candidate resources on a first CC of the set of multiple CCs based on the resource selection configuration. The sidelink control component 1150 may be configured as or otherwise support a means for transmitting a first sidelink control message indicating a carrier index of the first CC and a resource allocation corresponding to the first candidate resource. In some examples, the sidelink communication component 1135 may be configured as or otherwise support a means for communicating a first sidelink message within the first candidate resource of the shared radio frequency spectrum band using the first CC.

In some examples, to support transmitting the first sidelink control message, the sidelink control component 1150 may be configured as or otherwise support a means for transmitting the first sidelink control message indicating the resource allocation that indicates a time location, a frequency location, or both, of the first candidate resource.

In some examples, to support identifying the resource selection configuration, the resource selection configuration component 1140 may be configured as or otherwise support a means for identifying the resource selection configuration that indicates that the sensing window spans multiple CCs of the set of multiple CCs. In some examples, to support identifying the resource selection configuration, the resource selection component 1145 may be configured as or otherwise support a means for monitoring the multiple CCs within the sensing window, where the first candidate resource is selected based on the monitoring.

In some examples, the resource selection component 1145 may be configured as or otherwise support a means for identifying one or more resources available for reservation within the set of multiple candidate resources based on performing the sensing within the sensing window, where the first candidate resource is included in the one or more resources.

In some examples, to support identifying the resource selection configuration, the resource selection configuration component 1140 may be configured as or otherwise support a means for identifying the resource selection configuration that indicates an interference metric corresponding to a sidelink transmission gap. In some examples, to support identifying the resource selection configuration, the resource selection component 1145 may be configured as or otherwise support a means for determining a respective interference measurement for each CC of the set of multiple CCs based on the interference metric and performing the sensing within the sensing window, where the first candidate resource is selected based on the respective interference measurements.

In some examples, to support identifying the resource selection configuration, the resource selection configuration component 1140 may be configured as or otherwise support a means for identifying the resource selection configuration that indicates a sidelink channel occupancy metric. In some examples, to support identifying the resource selection configuration, the resource selection component 1145 may be configured as or otherwise support a means for determining a respective sidelink channel occupancy measurement for each CC of the set of multiple CCs based on the sidelink channel occupancy metric and performing the sensing within the sensing window, where the first candidate resource is selected based on the respective sidelink channel occupancy measurements.

In some examples, the resource selection component 1145 may be configured as or otherwise support a means for selecting a second candidate resource of the set of multiple candidate resources on a second CC of the set of multiple CCs based on performing the sensing within the sensing window. In some examples, the sidelink control component 1150 may be configured as or otherwise support a means for transmitting the first sidelink control message or a second sidelink control message indicating a carrier index of the second CC and a resource allocation corresponding to the second candidate resource. In some examples, the sidelink communication component 1135 may be configured as or otherwise support a means for communicating a second sidelink message within the second candidate resource of the shared radio frequency spectrum band using the second CC. In some examples, the first CC is different than the second CC.

FIG. 12 shows a diagram of a system 1200 including a device 1205 in accordance with aspects of the present disclosure. The device 1205 may be an example of or include the components of a device 905, a device 1005, or a UE 115 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting sidelink resource allocation in unlicensed spectrum). For example, the device 1205 or a component of the device 1205 may include a processor 1240 and memory 1230 coupled to the processor 1240, the processor 1240 and memory 1230 configured to perform various functions described herein.

The communications manager 1220 may support wireless communication at a UE in accordance with examples as disclosed herein. For example, the communications manager 1220 may be configured as or otherwise support a means for identifying a carrier selection configuration for selecting between a set of multiple CCs for sidelink communications within a shared radio frequency spectrum band. The communications manager 1220 may be configured as or otherwise support a means for selecting a first CC of the set of multiple CCs in accordance with the carrier selection configuration. The communications manager 1220 may be configured as or otherwise support a means for communicating a first sidelink message within a first resource of the shared radio frequency spectrum band using the first CC.

Additionally or alternatively, the communications manager 1220 may support wireless communication at a UE in accordance with examples as disclosed herein. For example, the communications manager 1220 may be configured as or otherwise support a means for identifying a resource selection configuration for resource selection between a set of multiple candidate resources of a set of multiple CCs for sidelink communications within a shared radio frequency spectrum band. The communications manager 1220 may be configured as or otherwise support a means for performing sensing within a sensing window for selecting a first candidate resource of the set of multiple candidate resources on a first CC of the set of multiple CCs based on the resource selection configuration. The communications manager 1220 may be configured as or otherwise support a means for transmitting a first sidelink control message indicating a carrier index of the first CC and a resource allocation corresponding to the first candidate resource. The communications manager 1220 may be configured as or otherwise support a means for communicating a first sidelink message within the first candidate resource of the shared radio frequency spectrum band using the first CC.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of sidelink resource allocation in unlicensed spectrum as described herein, or the processor 1240 and the memory 1230 may be otherwise configured to perform or support such operations.

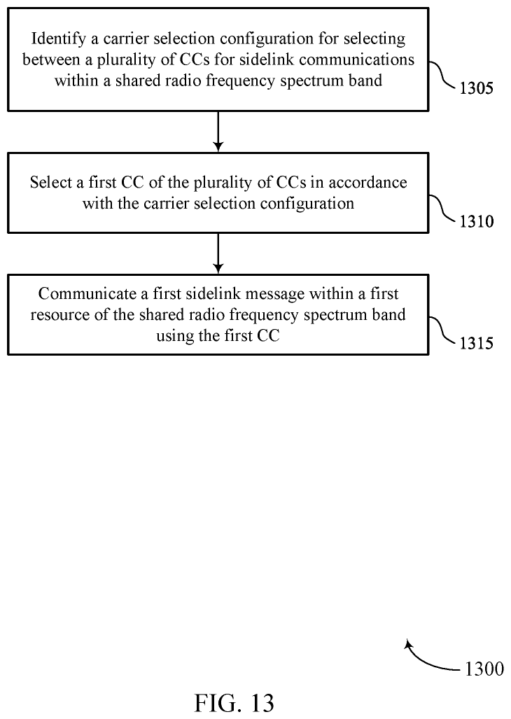

FIG. 13 shows a flowchart illustrating a method 1300 in accordance with aspects of the present disclosure. The operations of the method 1300 may be implemented by a UE or its components as described herein. For example, the operations of the method 1300 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 1305, the method may include identifying a carrier selection configuration for selecting between a set of multiple CCs for sidelink communications within a shared radio frequency spectrum band. The operations of 1305 may be performed in accordance with examples as disclosed herein. In some examples, aspects of the operations of 1305 may be performed by a carrier selection configuration component 1125 as described with reference to FIG. 11.

At 1310, the method may include selecting a first CC of the set of multiple CCs in accordance with the carrier selection configuration. The operations of 1310 may be performed in accordance with examples as disclosed herein. In some examples, aspects of the operations of 1310 may be performed by a carrier selection component 1130 as described with reference to FIG. 11.

At 1315, the method may include communicating a first sidelink message within a first resource of the shared radio frequency spectrum band using the first CC. The operations of 1315 may be performed in accordance with examples as disclosed herein. In some examples, aspects of the operations of 1315 may be performed by a sidelink communication component 1135 as described with reference to FIG. 11.

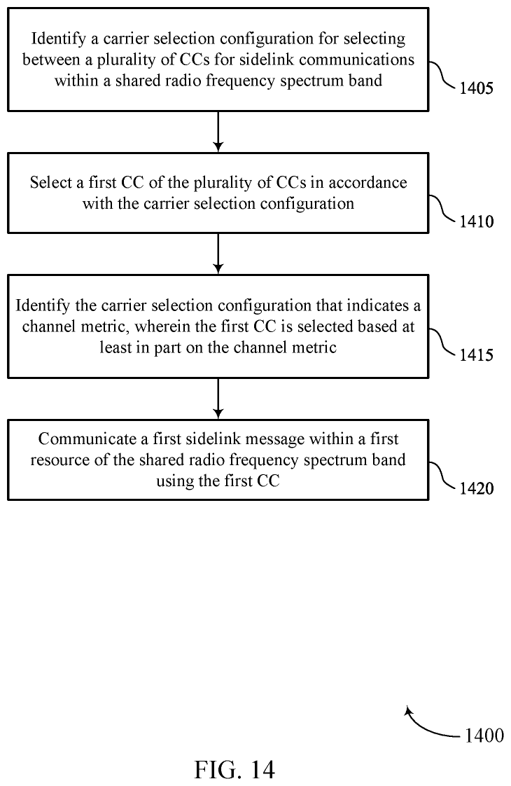

FIG. 14 shows a flowchart illustrating a method 1400 in accordance with aspects of the present disclosure. The operations of the method 1400 may be implemented by a UE or its components as described herein. For example, the operations of the method 1400 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 1405, the method may include identifying a carrier selection configuration for selecting between a set of multiple CCs for sidelink communications within a shared radio frequency spectrum band. The operations of 1405 may be performed in accordance with examples as disclosed herein. In some examples, aspects of the operations of 1405 may be performed by a carrier selection configuration component 1125 as described with reference to FIG. 11.

At 1410, the method may include selecting a first CC of the set of multiple CCs in accordance with the carrier selection configuration. The operations of 1410 may be performed in accordance with examples as disclosed herein. In some examples, aspects of the operations of 1410 may be performed by a carrier selection component 1130 as described with reference to FIG. 11.

At 1415, the method may include identifying the carrier selection configuration that indicates a channel metric, where the first CC is selected based on the channel metric. The operations of 1415 may be performed in accordance with examples as disclosed herein. In some examples, aspects of the operations of 1415 may be performed by a carrier selection configuration component 1125 as described with reference to FIG. 11.

At 1420, the method may include communicating a first sidelink message within a first resource of the shared radio frequency spectrum band using the first CC. The operations of 1420 may be performed in accordance with examples as disclosed herein. In some examples, aspects of the operations of 1420 may be performed by a sidelink communication component 1135 as described with reference to FIG. 11.

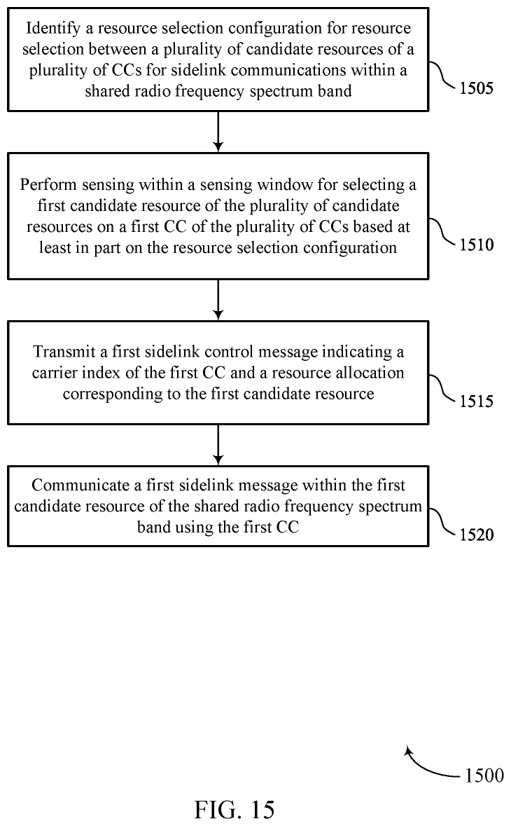

FIG. 15 shows a flowchart illustrating a method 1500 in accordance with aspects of the present disclosure. The operations of the method 1500 may be implemented by a UE or its components as described herein. For example, the operations of the method 1500 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 1505, the method may include identifying a resource selection configuration for resource selection between a set of multiple candidate resources of a set of multiple CCs for sidelink communications within a shared radio frequency spectrum band. The operations of 1505 may be performed in accordance with examples as disclosed herein. In some examples, aspects of the operations of 1505 may be performed by a resource selection configuration component 1140 as described with reference to FIG. 11.

At 1510, the method may include performing sensing within a sensing window for selecting a first candidate resource of the set of multiple candidate resources on a first CC of the set of multiple CCs based on the resource selection configuration. The operations of 1510 may be performed in accordance with examples as disclosed herein. In some examples, aspects of the operations of 1510 may be performed by a resource selection component 1145 as described with reference to FIG. 11.

At 1515, the method may include transmitting a first sidelink control message indicating a carrier index of the first CC and a resource allocation corresponding to the first candidate resource. The operations of 1515 may be performed in accordance with examples as disclosed herein. In some examples, aspects of the operations of 1515 may be performed by a sidelink control component 1150 as described with reference to FIG. 11.

At 1520, the method may include communicating a first sidelink message within the first candidate resource of the shared radio frequency spectrum band using the first CC. The operations of 1520 may be performed in accordance with examples as disclosed herein. In some examples, aspects of the operations of 1520 may be performed by a sidelink communication component 1135 as described with reference to FIG. 11.

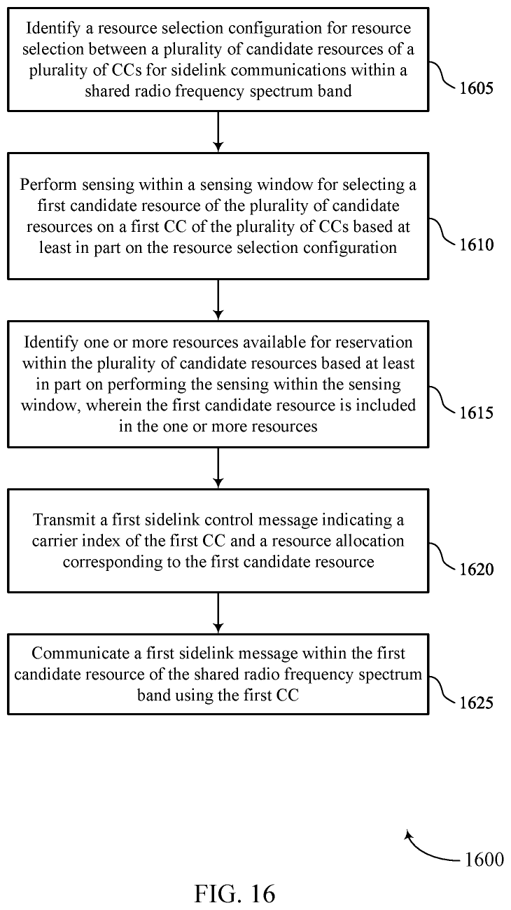

FIG. 16 shows a flowchart illustrating a method 1600 in accordance with aspects of the present disclosure. The operations of the method 1600 may be implemented by a UE or its components as described herein. For example, the operations of the method 1600 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 1605, the method may include identifying a resource selection configuration for resource selection between a set of multiple candidate resources of a set of multiple CCs for sidelink communications within a shared radio frequency spectrum band. The operations of 1605 may be performed in accordance with examples as disclosed herein. In some examples, aspects of the operations of 1605 may be performed by a resource selection configuration component 1140 as described with reference to FIG. 11.

At 1610, the method may include performing sensing within a sensing window for selecting a first candidate resource of the set of multiple candidate resources on a first CC of the set of multiple CCs based on the resource selection configuration. The operations of 1610 may be performed in accordance with examples as disclosed herein. In some examples, aspects of the operations of 1610 may be performed by a resource selection component 1145 as described with reference to FIG. 11.

At 1615, the method may include identifying one or more resources available for reservation within the set of multiple candidate resources based on performing the sensing within the sensing window, where the first candidate resource is included in the one or more resources. The operations of 1615 may be performed in accordance with examples as disclosed herein. In some examples, aspects of the operations of 1615 may be performed by a resource selection component 1145 as described with reference to FIG. 11.

At 1620, the method may include transmitting a first sidelink control message indicating a carrier index of the first CC and a resource allocation corresponding to the first candidate resource. The operations of 1620 may be performed in accordance with examples as disclosed herein. In some examples, aspects of the operations of 1620 may be performed by a sidelink control component 1150 as described with reference to FIG. 11.

At 1625, the method may include communicating a first sidelink message within the first candidate resource of the shared radio frequency spectrum band using the first CC. The operations of 1625 may be performed in accordance with examples as disclosed herein. In some examples, aspects of the operations of 1625 may be performed by a sidelink communication component 1135 as described with reference to FIG. 11.

The following provides an overview of aspects of the present disclosure:

Aspect 1: A method for wireless communication at a UE, comprising: identifying a carrier selection configuration for selecting between a plurality of CCs for sidelink communications within a shared radio frequency spectrum band; selecting a first CC of the plurality of CCs in accordance with the carrier selection configuration; and communicating a first sidelink message within a first resource of the shared radio frequency spectrum band using the first CC.

Aspect 2: The method of aspect 1, wherein identifying the carrier selection configuration comprises: identifying the carrier selection configuration that indicates a channel metric, wherein the first CC is selected based at least in part on the channel metric.

Aspect 3: The method of any of aspects 1 through 2, wherein identifying the carrier selection configuration comprises: identifying the carrier selection configuration that indicates a time window and a channel metric; and monitoring the plurality of CCs within the time window based at least in part on the channel metric, wherein the first CC is selected based at least in part on the monitoring.

Aspect 4: The method of any of aspects 1 through 3, wherein identifying the carrier selection configuration comprises: identifying the carrier selection configuration that indicates an interference metric; and monitoring the plurality of CCs based at least in part on the interference metric, wherein the first CC is selected based at least in part on the monitoring indicating that the first CC satisfies an interference criterion associated with the interference metric.

Aspect 5: The method of any of aspects 1 through 4, wherein identifying the carrier selection configuration comprises: identifying the carrier selection configuration that indicates a sidelink congestion metric; and monitoring the plurality of CCs based at least in part on the sidelink congestion metric, wherein the first CC is selected based at least in part on the monitoring indicating that the first CC satisfies a congestion criterion associated with the sidelink congestion metric.

Aspect 6: The method of any of aspects 1 through 5, wherein identifying the carrier selection configuration comprises: identifying the carrier selection configuration that indicates an interference metric corresponding to a sidelink transmission gap; and monitoring the plurality of CCs within the sidelink transmission gap based at least in part on the interference metric, wherein the first CC is selected based at least in part on the monitoring indicating that the first CC satisfies an interference criterion associated with the interference metric for the sidelink transmission gap.

Aspect 7: The method of any of aspects 1 through 6, wherein identifying the carrier selection configuration comprises: identifying the carrier selection configuration that indicates a resource reservation monitoring configuration; and monitoring at least one resource on at least one of the plurality of CCs based at least in part on the resource reservation monitoring configuration, wherein the first CC is selected based at least in part on the monitoring indicating that the at least one resource on the at least one of the plurality of CCs satisfies a resource reservation criterion.

Aspect 8: The method of any of aspects 1 through 7, wherein identifying the carrier selection configuration comprises: identifying the carrier selection configuration that indicates a congestion control metric; and monitoring the plurality of CCs based at least in part on the congestion control metric, wherein the first CC is selected based at least in part on the monitoring indicating that the first CC satisfies a congestion control criterion associated with the congestion control metric.

Aspect 9: The method of any of aspects 1 through 8, further comprising: identifying a carrier reselection configuration associated with the carrier selection configuration; monitoring the plurality of CCs to select a second CC based at least in part on the carrier reselection configuration; and communicating a second sidelink message within a second resource of the shared radio frequency spectrum band using the second CC.

Aspect 10: The method of any of aspects 1 through 9, further comprising: selecting the first resource and a second resource of the shared radio frequency spectrum band corresponding to the first CC, wherein the first sidelink message indicates the second resource.

Aspect 11: The method of any of aspects 1 through 10, wherein identifying the carrier selection configuration comprises: identifying the carrier selection configuration that indicates a plurality of metrics; and monitoring the plurality of CCs based at least in part on the plurality of metrics, wherein the first CC is selected based at least in part on the monitoring.

Aspect 12: A method for wireless communication at a UE, comprising: identifying a resource selection configuration for resource selection between a plurality of candidate resources of a plurality of CCs for sidelink communications within a shared radio frequency spectrum band; performing sensing within a sensing window for selecting a first candidate resource of the plurality of candidate resources on a first CC of the plurality of CCs based at least in part on the resource selection configuration; transmitting a first sidelink control message indicating a carrier index of the first CC and a resource allocation corresponding to the first candidate resource; and communicating a first sidelink message within the first candidate resource of the shared radio frequency spectrum band using the first CC.

Aspect 13: The method of aspect 12, wherein transmitting the first sidelink control message comprises: transmitting the first sidelink control message indicating the resource allocation that indicates a time location, a frequency location, or both, of the first candidate resource.

Aspect 14: The method of any of aspects 12 through 13, wherein identifying the resource selection configuration comprises: identifying the resource selection configuration that indicates that the sensing window spans multiple CCs of the plurality of CCs; and monitoring the multiple CCs within the sensing window, wherein the first candidate resource is selected based at least in part on the monitoring.

Aspect 15: The method of any of aspects 12 through 14, further comprising: identifying one or more resources available for reservation within the plurality of candidate resources based at least in part on performing the sensing within the sensing window, wherein the first candidate resource is included in the one or more resources.

Aspect 16: The method of any of aspects 12 through 15, wherein identifying the resource selection configuration comprises: identifying the resource selection configuration that indicates an interference metric corresponding to a sidelink transmission gap; and determining a respective interference measurement for each CC of the plurality of CCs based at least in part on the interference metric and performing the sensing within the sensing window, wherein the first candidate resource is selected based at least in part on the respective interference measurements.

Aspect 17: The method of any of aspects 12 through 16, wherein identifying the resource selection configuration comprises: identifying the resource selection configuration that indicates a sidelink channel occupancy metric; determining a respective sidelink channel occupancy measurement for each CC of the plurality of CCs based at least in part on the sidelink channel occupancy metric and performing the sensing within the sensing window, wherein the first candidate resource is selected based at least in part on the respective sidelink channel occupancy measurements.

Aspect 18: The method of any of aspects 12 through 17, further comprising: selecting a second candidate resource of the plurality of candidate resources on a second CC of the plurality of CCs based at least in part on performing the sensing within the sensing window; transmitting the first sidelink control message or a second sidelink control message indicating a carrier index of the second CC and a resource allocation corresponding to the second candidate resource; and communicating a second sidelink message within the second candidate resource of the shared radio frequency spectrum band using the second CC.

Aspect 19: The method of aspect 18, wherein the first CC is different than the second CC.

Aspect 20: An apparatus for wireless communication at a UE, comprising a processor; memory coupled with the processor; and instructions stored in the memory and executable by the processor to cause the apparatus to perform a method of any of aspects 1 through 11.

Aspect 21: An apparatus for wireless communication at a UE, comprising at least one means for performing a method of any of aspects 1 through 11.

Aspect 22: A non-transitory computer-readable medium storing code for wireless communication at a UE, the code comprising instructions executable by a processor to perform a method of any of aspects 1 through 11.

Aspect 23: An apparatus for wireless communication at a UE, comprising a processor; memory coupled with the processor; and instructions stored in the memory and executable by the processor to cause the apparatus to perform a method of any of aspects 12 through 19.

Aspect 24: An apparatus for wireless communication at a UE, comprising at least one means for performing a method of any of aspects 12 through 19.

Aspect 25: A non-transitory computer-readable medium storing code for wireless communication at a UE, the code comprising instructions executable by a processor to perform a method of any of aspects 12 through 19.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
identifying a carrier selection configuration for selecting between a plurality of component carriers for sidelink communications within a shared radio frequency spectrum band;
selecting a first component carrier of the plurality of component carriers in accordance with the carrier selection configuration; and
communicating a first sidelink message within a first resource of the shared radio frequency spectrum band using the first component carrier.

2. The method of claim 1, wherein identifying the carrier selection configuration comprises:
identifying the carrier selection configuration that indicates a channel metric, wherein the first component carrier is selected based at least in part on the channel metric.

3. The method of claim 1, wherein identifying the carrier selection configuration comprises:
identifying the carrier selection configuration that indicates a time window and a channel metric; and
monitoring the plurality of component carriers within the time window based at least in part on the channel metric, wherein the first component carrier is selected based at least in part on the monitoring.

4. The method of claim 1, wherein identifying the carrier selection configuration comprises:
identifying the carrier selection configuration that indicates an interference metric; and
monitoring the plurality of component carriers based at least in part on the interference metric, wherein the first component carrier is selected based at least in part on the monitoring indicating that the first component carrier satisfies an interference criterion associated with the interference metric.

5. The method of claim 66, wherein identifying the carrier selection configuration comprises:
identifying the carrier selection configuration that indicates a sidelink congestion metric; and
monitoring the plurality of component carriers based at least in part on the sidelink congestion metric, wherein the first component carrier is selected based at least in part on the monitoring indicating that the first component carrier satisfies a congestion criterion associated with the sidelink congestion metric.

6. The method of claim 1, wherein identifying the carrier selection configuration comprises:
identifying the carrier selection configuration that indicates an interference metric corresponding to a sidelink transmission gap; and
monitoring the plurality of component carriers within the sidelink transmission gap based at least in part on the interference metric, wherein the first component carrier is selected based at least in part on the monitoring indicating that the first component carrier satisfies an interference criterion associated with the interference metric for the sidelink transmission gap.

7. The method of claim 1, wherein identifying the carrier selection configuration comprises:
identifying the carrier selection configuration that indicates a resource reservation monitoring configuration; and
monitoring at least one resource on at least one of the plurality of component carriers based at least in part on the resource reservation monitoring configuration, wherein the first component carrier is selected based at least in part on the monitoring indicating that the at least one resource on the at least one of the plurality of component carriers satisfies a resource reservation criterion.

8. The method of claim 1, wherein identifying the carrier selection configuration comprises:
identifying the carrier selection configuration that indicates a congestion control metric; and
monitoring the plurality of component carriers based at least in part on the congestion control metric, wherein the first component carrier is selected based at least in part on the monitoring indicating that the first component carrier satisfies a congestion control criterion associated with the congestion control metric.

9. The method of claim 1, further comprising:
identifying a carrier reselection configuration associated with the carrier selection configuration;
monitoring the plurality of component carriers to select a second component carrier based at least in part on the carrier reselection configuration; and
communicating a second sidelink message within a second resource of the shared radio frequency spectrum band using the second component carrier.

10. The method of claim 1, further comprising:
selecting the first resource and a second resource of the shared radio frequency spectrum band corresponding to the first component carrier, wherein the first sidelink message indicates the second resource.

11. The method of claim 1, wherein identifying the carrier selection configuration comprises:
identifying the carrier selection configuration that indicates a plurality of metrics; and
monitoring the plurality of component carriers based at least in part on the plurality of metrics, wherein the first component carrier is selected based at least in part on the monitoring.

12. A method for wireless communication at a user equipment (UE), comprising:
identifying a resource selection configuration for resource selection between a plurality of candidate resources of a plurality of component carriers for sidelink communications within a shared radio frequency spectrum band;
performing sensing within a sensing window for selecting a first candidate resource of the plurality of candidate resources on a first component carrier of the plurality of component carriers based at least in part on the resource selection configuration;
transmitting a first sidelink control message indicating a carrier index of the first component carrier and a resource allocation corresponding to the first candidate resource; and
communicating a first sidelink message within the first candidate resource of the shared radio frequency spectrum band using the first component carrier.

13. The method of claim 12, wherein transmitting the first sidelink control message comprises:
transmitting the first sidelink control message indicating the resource allocation that indicates a time location, a frequency location, or both, of the first candidate resource.

14. The method of claim 12, wherein identifying the resource selection configuration comprises:
identifying the resource selection configuration that indicates that the sensing window spans multiple component carriers of the plurality of component carriers; and
monitoring the multiple component carriers within the sensing window, wherein the first candidate resource is selected based at least in part on the monitoring.

15. The method of claim 12, further comprising:
identifying one or more resources available for reservation within the plurality of candidate resources based at least in part on performing the sensing within the sensing window, wherein the first candidate resource is included in the one or more resources.

16. The method of claim 12, wherein identifying the resource selection configuration comprises:
identifying the resource selection configuration that indicates an interference metric corresponding to a sidelink transmission gap; and
determining a respective interference measurement for each component carrier of the plurality of component carriers based at least in part on the interference metric and performing the sensing within the sensing window, wherein the first candidate resource is selected based at least in part on the respective interference measurements.

17. The method of claim 12, wherein identifying the resource selection configuration comprises:
identifying the resource selection configuration that indicates a sidelink channel occupancy metric;
determining a respective sidelink channel occupancy measurement for each component carrier of the plurality of component carriers based at least in part on the sidelink channel occupancy metric and performing the sensing within the sensing window, wherein the first candidate resource is selected based at least in part on the respective sidelink channel occupancy measurements.

18. The method of claim 12, further comprising:
selecting a second candidate resource of the plurality of candidate resources on a second component carrier of the plurality of component carriers based at least in part on performing the sensing within the sensing window;
transmitting the first sidelink control message or a second sidelink control message indicating a carrier index of the second component carrier and a resource allocation corresponding to the second candidate resource; and
communicating a second sidelink message within the second candidate resource of the shared radio frequency spectrum band using the second component carrier.

19. The method of claim 18, wherein the first component carrier is different than the second component carrier.

20. An apparatus for wireless communication at a user equipment (UE), comprising:
a processor;
memory coupled with the processor; and
instructions stored in the memory and executable by the processor to cause the apparatus to:
identify a carrier selection configuration for selecting between a plurality of component carriers for sidelink communications within a shared radio frequency spectrum band;
select a first component carrier of the plurality of component carriers in accordance with the carrier selection configuration; and
communicate a first sidelink message within a first resource of the shared radio frequency spectrum band using the first component carrier.

21. The apparatus of claim 70, wherein the instructions to identify the carrier selection configuration are executable by the processor to cause the apparatus to:
identify the carrier selection configuration that indicates a channel metric, wherein the first component carrier is selected based at least in part on the channel metric.

22. The apparatus of claim 20, further comprising an antenna, wherein the instructions to identify the carrier selection configuration are executable by the processor to cause the apparatus to:
identify the carrier selection configuration that indicates a time window and a channel metric; and
monitor the plurality of component carriers within the time window based at least in part on the channel metric, wherein the first component carrier is selected based at least in part on the monitoring.

23. The apparatus of claim 20, wherein the instructions are further executable by the processor to cause the apparatus to:
identify a carrier reselection configuration associated with the carrier selection configuration;
monitor the plurality of component carriers to select a second component carrier based at least in part on the carrier reselection configuration; and
communicate a second sidelink message within a second resource of the shared radio frequency spectrum band using the second component carrier.

24. The apparatus of claim 20, wherein the instructions are further executable by the processor to cause the apparatus to:
select the first resource and a second resource of the shared radio frequency spectrum band corresponding to the first component carrier, wherein the first sidelink message indicates the second resource.

25. The apparatus of claim 20, wherein the instructions to identify the carrier selection configuration are executable by the processor to cause the apparatus to:
identify the carrier selection configuration that indicates a plurality of metrics; and
monitor the plurality of component carriers based at least in part on the plurality of metrics, wherein the first component carrier is selected based at least in part on the monitoring.

26. An apparatus for wireless communication at a user equipment (UE), comprising:
a processor;
memory coupled with the processor; and
instructions stored in the memory and executable by the processor to cause the apparatus to:
identify a resource selection configuration for resource selection between a plurality of candidate resources of a plurality of component carriers for sidelink communications within a shared radio frequency spectrum band;
perform sensing within a sensing window for selecting a first candidate resource of the plurality of candidate resources on a first component carrier of the plurality of component carriers based at least in part on the resource selection configuration;
transmit a first sidelink control message indicating a carrier index of the first component carrier and a resource allocation corresponding to the first candidate resource; and
communicate a first sidelink message within the first candidate resource of the shared radio frequency spectrum band using the first component carrier.

27. The apparatus of claim 26, further comprising an antenna, wherein the instructions to identify the resource selection configuration are executable by the processor to cause the apparatus to:
identify the resource selection configuration that indicates that the sensing window spans multiple component carriers of the plurality of component carriers; and
monitor the multiple component carriers within the sensing window, wherein the first candidate resource is selected based at least in part on the monitoring.

28. The apparatus of claim 26, wherein the instructions are further executable by the processor to cause the apparatus to:
identify one or more resources available for reservation within the plurality of candidate resources based at least in part on performing the sensing within the sensing window, wherein the first candidate resource is included in the one or more resources.

29. The apparatus of claim 26, wherein the instructions are further executable by the processor to cause the apparatus to:
select a second candidate resource of the plurality of candidate resources on a second component carrier of the plurality of component carriers based at least in part on performing the sensing within the sensing window;
transmit the first sidelink control message or a second sidelink control message indicating a carrier index of the second component carrier and a resource allocation corresponding to the second candidate resource; and
communicate a second sidelink message within the second candidate resource of the shared radio frequency spectrum band using the second component carrier.

30. The apparatus of claim 29, wherein the first component carrier is different than the second component carrier.
